(19) United States
(12) Patent Application Publication
(10) Pub. No.: US 2025/0141839 A1
(43) Pub. Date: May 1, 2025

(54) Cloud-Based Application Resource Mapping

(71) Applicant: Illumio, Inc., Sunnyvale, CA (US)

(72) Inventors: Swapnil Satish Ayachit, Sunnyvale, CA (US); Alberto Salazar, JR., La Habra, CA (US); Ammar Tariq, Brampton (CA); Daniel Issamu Kawata, North York (CA); Anand Jayaraman, Cupertino, CA (US); Nidhi Kannoujia, Santa Clara, CA (US)

(21) Appl. No.: 18/919,858

(22) Filed: Oct. 18, 2024

Related U.S. Application Data
(60) Provisional application No. 63/593,518, filed on Oct. 26, 2023.

(51) Int. Cl. H04L 9/40

(52) U.S. Cl. CPC H04L 63/0227; H04L 63/10; H04L 63/20

(57) ABSTRACT

A method for managing security in a cloud computing environment. The method includes obtaining metadata related to the deployment of an application, where the deployment is associated with one or more cloud resources. The method assigns first labels to the cloud resources based on the metadata and second labels based on user input. These labels may include environment and application identifiers. A security ruleset is then generated based on the assigned labels and applied to the resources associated with the application deployment. The method continuously monitors metadata to detect changes in the application and updates the security ruleset accordingly to ensure ongoing protection and control over network traffic involving the application resources.

### CROSS REFERENCE TO RELATED APPLICATION

The application claims the benefit of U.S. Provisional Patent Application No. 63/593,518, filed Oct. 26, 2023, which is incorporated by reference in its entirety.

### BACKGROUND

Public cloud computing has significantly changed the digital landscape by allowing access to computing resources, platforms, and software without the need for physical infrastructure owned or directly managed by businesses. This change has helped drive innovation across various sectors, allowing enterprises to scale their operations, reduce costs, and improve efficiency with on-demand access to services. Cloud services include Infrastructure as a Service (IaaS), Platform as a Service (PaaS), and Software as a Service (SaaS), each serving different needs in the technology ecosystem.

Despite the numerous advantages offered by IaaS, PaaS, and SaaS, their deployment raises significant challenges, particularly regarding security. One of the primary concerns is the isolated architectural design adopted by cloud providers. Each provider typically develops their infrastructure, platform, and software solutions independently, following their proprietary protocols and security measures. This isolation can lead to a fragmented security landscape where the measures implemented by one service may not be compatible or integrable with those of another.

The disparate array of security measures complicates the task of ensuring comprehensive protection across services. Enterprises leveraging multiple cloud services must navigate these inconsistencies, potentially exposing their operations to vulnerabilities and threats. The lack of standardization in security protocols across providers amplifies these challenges, making it difficult for businesses to maintain a unified and robust security posture.

### SUMMARY

Embodiments described herein relate to a method for managing network segmentation policies in a cloud computing environment. The method includes collecting cloud metadata associated with cloud resources from one or more cloud service providers, with the cloud resources being protected by a plurality of segmentation policies and determining relationships between different cloud resources associated with the segmentation policies based on the collected cloud metadata. In some embodiments, the relationships are visualized on a graphical user interface (GUI). The method also includes recording the determined relationships in a database; configuring a network segmentation policy based on the determined relationships, wherein the network segmentation policy dictates whether network traffic between cloud resources is allowed or denied; collecting flow logs from different sources and analyzing the traffic flow data to depict visually and to enable the end user to determine that the segmentation policy is effective and then cloud native control performing one of allowing passage of network traffic or blocking network traffic to or from cloud resources based on the configured network segmentation policies.

Embodiments described herein also relate to a method for managing new cloud resources in a cloud computing environment. The method includes detecting when a new cloud resource is created in the cloud computing environment; obtaining metadata for the new cloud resource; comparing metadata of new cloud resource with the metadata of existing cloud resources in the cloud computing environment for particular metadata fields to gather similarities and accordingly classify new cloud resources; identifying a security rule that controls network traffic to or from the identified existing cloud resource; and updating the security rule to also control network traffic to or from the new cloud resource, or generating a new security rule that controls network traffic to or from the new cloud resource. The updated or new security rule permits or prohibits the new cloud resource from communicating with one or more other cloud resources, mirroring the communication permissions or restrictions of the identified existing cloud resource.

Embodiments described herein also relate to a method for managing security rules in a cloud computing environment. The method includes detecting the creation of a new cloud account in the cloud computing environment; obtaining metadata associated with the new cloud account; comparing the metadata of the new cloud account with that of existing cloud accounts in the cloud computing environment to identify an existing cloud account similar to the new one; identifying a set of security rules associated with the identified existing cloud account; generating a new set of security rules for the new cloud account based on the set of security rule associated with the existing cloud account; monitoring the security rules of the existing cloud account for any changes; and propagating the change in the set of the security rules in response to the detection of a change in the set of security rules.

Embodiments described herein also relate to a method for managing the deployment of applications in a cloud computing environment. This method includes obtaining metadata associated with a deployment of an application in the cloud computing environment, where the deployment is associated with one or more cloud resources. These cloud resources are assigned labels based on their respective metadata, which include an environment label indicating the application's running environment and an application label specifying the application's name. A security rule is then generated based on the labels assigned to the resources associated with the deployment of the application and applied to these resources. The method also involves monitoring the metadata associated with the deployment of the application to detect any changes in the application. Upon detecting a change, the security rule is updated accordingly.

### BRIEF DESCRIPTION OF THE DRAWINGS

Figure (FIG. 1 is a high-level block diagram illustrating a networked computing environment for managing segmentation in accordance with one or more embodiments.

FIG. 2 illustrates example embodiments of an operating system (OS) instance in accordance with one or more embodiments.

FIG. 3 illustrates one embodiment of the segmentation server in accordance with one or more embodiments.

FIG. 4A illustrates an example graphical user interface (GUI) that visualizes different resources in different cloud accounts associated with an enterprise, in accordance with one or more embodiments.

FIG. 4B illustrates an example GUI that visualizes a list view of all resources in a cloud computing environment in accordance with one or more embodiments.

FIG. 4C illustrates an example GUI that visualizes discovered applications in a cloud computing environment in accordance with one or more embodiments.

FIG. 4D illustrates an example GUI that visualizes a map view of an application in accordance with one or more embodiments.

FIG. 4E illustrates an example GUI that visualizes a view of traffic flow associated with a particular resource in accordance with one or more embodiments.

FIG. 4F illustrates an example GUI that visualizes a table view of the relationships between different resources of an application in accordance with one or more embodiments.

FIG. 4G illustrates an example GUI that allows a user to create a deny rule or an allow rule by simply selecting a tag for a source resource and a tag for a destination resource in accordance with one or more embodiments.

FIG. 4H illustrates an example GUI displaying a detailed summary of a relational database service (RDS) database instance in accordance with one or more embodiments.

FIG. 4I illustrates an example GUI listing resources associated with an RDS database instance in accordance with one or more embodiments.

FIG. 4J illustrates an example GUI including a circular graph that visualizes resources associated with an RDS database instance and their relationships in accordance with one or more embodiments.

FIG. 4K illustrates an example GUI displaying a detailed summary of a virtual machine (VM) instance in accordance with one or more embodiments.

FIG. 4L illustrates an example GUI listing resources associated with a virtual machine (VM) instance in accordance with one or more embodiments.

FIG. 4M illustrates an example GUI including a circular graph that visualizes resources for a VM instance and their relationships in accordance with one or more embodiments.

FIG. 5 illustrates an example environment that includes a virtual machine instance (VM1) established in a public cloud in a particular region, such as AWS in an east US region in accordance with one or more embodiments.

FIG. 6 illustrates an example environment that includes a virtual machine (VM1) associated with multi-level control in accordance with one or more embodiments.

FIG. 7 illustrates an example sync service domain, in which a cloud security module is configured to synchronize metadata about cloud resources and identify their relationships in accordance with one or more embodiments.

FIG. 8 is a flowchart of an example method for configuring network segmentation policies in accordance with one or more embodiments.

FIG. 9 illustrates an example virtual private cloud computing environment, including three levels of controls.

FIG. 10 is a flowchart of an example method for generating a network segmentation policy in accordance with one or more embodiments.

FIG. 11 illustrates an example cloud computing environment under a single AWS account that includes two virtual private clouds (VPCs) in accordance with one or more embodiments.

FIG. 12 is a flowchart of a method for automatically generating a new segmentation policy or modifying an existing segmentation policy in accordance with one or more embodiments.

FIG. 13 is a flowchart of an example method for determining a control level at which a security rule is to be enforced in accordance with one or more embodiments.

FIG. 14 is a flowchart of workflow for onboarding a new tenant or a new enterprise in a cloud computing environment in accordance with one or more embodiments.

FIG. 15 is a flowchart of a method for generating and enforcing segmentation policies in new cloud accounts in accordance with one or more embodiments.

FIG. 16 is a flowchart of an example method for discovering and segmentation governance of applications in a cloud computing environment, in accordance with one or more embodiments.

FIG. 17 is a block diagram of an example computer suitable for use in the networked computing environment of FIG. 1 in accordance with one or more embodiments.

### DETAILED DESCRIPTION

Enterprises have increasingly used various public cloud services such as Infrastructure as a Service (IaaS), Platform as a Service (PaaS), and Software as a Service (SaaS). These services offer resources that users can access for their needs. However, a problem is that these services are often developed separately by cloud providers, leading to each having its own security controls, which can differ greatly. A security control is an enforcement point governed by policies that manage the traffic going in and out of the service or its instance.

Currently, no single tool can provide enterprises with comprehensive visibility into all levels of security controls on a visual map, nor does one allow for the creation of human-readable segmentation policies utilizing these controls. While there are tools that may orchestrate specific policies within each control individually, and it may be possible to manage these manually or through some automation if the precise policies to be programmed into each security control are known, the challenge escalates significantly when dealing with over 2000 controls. Beyond that, it becomes nearly impractical to maintain and update the policies continuously.

Further, cloud resources across different cloud platforms, such as Azure and AWS, include distinct security enforcement points at various levels within the cloud network architecture, making it challenging to consolidate a set of policies that will influence a cloud-based resource effectively. As described above, this problem is evident, yet there are no tools to manage every aspect of each security control comprehensively. Alternatively, opting not to enforce controls leaves the system vulnerable to breaches. This dilemma highlights the need for sophisticated solutions to bridge the gap between comprehensive security management and practical implementation, ensuring that security measures are effective and manageable.

Solutions for the above-described and other problems may be provided by generating a graph of an enterprise cloud using cloud metadata gathered from their respective cloud providers and interpreting the metadata through the use of relationships between different resources. Application programming interfaces (APIs) provided by cloud providers may be configured to collect metadata about a wide range of services (such as virtual machines and platform as a service), networking details (including virtual networks, Virtual Private Clouds (VPCs), and subnets), as well as security mechanisms (like security groups (SGs) or Network Security Groups (NSGs), Network Access Control Lists (NACLs), and firewalls). Upon gathering this metadata, connections between each resource type and policy type are established, and these relationships may be represented by a data structure, such as a graph, and stored in a graph database or postgres database or a combination of both. The data structure storing the relationships enables precise determination of the security controls and policies applicable to any given service or resource by executing queries against the database. Leveraging this data, embodiments described herein are capable of analyzing various network pathways, mapping real-time traffic flows to specific resources, and showcasing potential vulnerabilities where segmentation policies could be strengthened.

### Example System Environment

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

FIG. 1 illustrates one embodiment of a networked computing environment 100. In the embodiment shown, the networked computing environment 100 includes a segmentation server 120, a network 110, an administrative client 160, one or more cloud resources 170, and an administrative domain 150 that includes a plurality of operating system (OS) instances 130 (e.g., OS instances 130-1, 130-2, . . . , 130-N). The one or more cloud resources 170 may be hosted via cloud services, such as Amazon web services (AWS), Azure, GCP or OCI. The administrative domain 150 can correspond to an enterprise such as, for example, a service provider, a corporation, a university, or a government agency under control of the segmentation server 120. The enterprise may have one or more accounts established with any cloud service, such as AWS, Azure, GCP or OCI. The cloud resources 170 may be created within the one or more accounts. The cloud resources 170 may include (but are not limited to) virtual machines (VMs), subnets, and/or virtual private clouds (VPCs) or Virtual Networks (VNETs).

The network 110 represents the communication pathways between the segmentation server 120, the administrative client 160, and the OS instances 130. In one embodiment, the network 110 uses standard communications technologies and/or protocols and can include the Internet. In another embodiment, the enterprises on the network 110 can use custom and/or dedicated data communications technologies.

The OS instances 130 comprise instances of an operating system executing on one or more computing devices. An OS instance 130 may execute directly on a physical machine or on a virtual machine that executes on one or more computing devices. A single physical or virtual machine may operate a single OS instance 130 or may operate multiple OS instances 130

The OS instances 130 each execute one or more workloads 138 (e.g., one or more workloads 138-1, one or more workloads 138-2, etc.). The workloads 138 comprise independently addressable computing units for performing computing tasks. A workload 138 may comprise, for example, an application or application component, a process, a container, or other sub-component thereof executing on the OS instance 130. In some instances, an OS instance 130 may operate only a single workload 138. In other instances, an OS instance 130 may operate multiple workloads 138 that may be independently addressable and may perform different independent computing functions. The workloads 138 on the OS instances 130 may communicate with other workloads 138 on different OS instances 130 within the administrative domain 150 to perform various tasks.

A workload 138 communicates over one or more ports 134. A port 134 comprises a logical communication endpoint for a particular service that is provided by or used by a workload 138. A port 134 on a workload 138 may be identified by a port identifier that may specify, for example, an IP address associated with the workload 138 and a port number. Specific port numbers may be used consistently across different workloads 138 in association with specific services. Thus, the port number can often identify the service and vice versa. For example, port 80 is typically used for hyper-text transfer protocol (HTTP) traffic on any workloads 138 that provide or consume HTTP-based web services and port 5432 is typically used for any TCP traffic associated with PostgreSQL database services. In other instances, the same services on different workloads 138 may utilize different port numbers that are not necessarily consistent, or different services may utilize the same port numbers.

The segmentation server 120 is a computer (or set of computers) that obtains and stores information about the OS instances 130 on the network 110 and the workloads 138 executing on the OS instances 130. The segmentation server 120 manages a network segmentation policy for the administrative domain 150 that regulates communications between workloads 138 within the administrative domain 150. In an embodiment, the network segmentation policy is set forth using permissive policies that specify the communications that are permitted. The network segmentation policy is enforced by blocking any communications that are not expressly permitted by the policies. For example, the network segmentation policy includes a set of policies specifying whether certain workloads 138 are allowed to provide services to or receive services from other workloads 138, and may place restrictions on how those workloads 138 are allowed to communicate when providing or consuming the services. For example, a network segmentation policy may include a policy specifying that a workload 138-1 operating on an OS instance 130-1 is allowed to provide a particular service to a workload 138-2 operating on an OS instance 130-2. Absent other policies, the workload 138-1 will thus be blocked from providing the service to a workload 138-N operating on an OS instance 130-N. The policy may furthermore specify the type of service that the workload 138-1 is allowed to provide to workload 138-2 (e.g., a database service, a web service, etc.). Additionally, the policy may specify how the workloads 138-1, 138-2 may communicate when providing this service (e.g., using encrypted communication only, using authenticated communication only, etc.). A policy may be specified as a plurality of fields including a “service,” a “provided-by” portion that identifies one or more workloads 138 that is permitted to provide the service (which may be specified by a port number), a “used-by” portion that identifies one or more workloads 138 that is permitted to use the service provided by the workloads 138 in the “provided-by portion,” and a “policy function” that may place one or more restrictions on the communications between the workloads 138 while facilitating the service.

In an embodiment, the segmentation server 120 may assign one or more labels to each workload 138 that define one or more high-level characteristics of the workload 138. Labels may be multi-dimensional. Here, a label may comprise a “dimension” (a high-level characteristic) and a “value” (the value of that high-level characteristic). For example, one possible label dimension may specify a “role” of the workload 138 and may have values such as “web,” “API,” or “database” specifying the role of the workload 138 within the administrative domain 150. In another example, a label dimension may specify a “location” of the workload 138 and may have values such as “United States” or “Europe.” Workloads 138 may also be labeled based on a user group of a user that is logged into the workload 138 or the corresponding OS instance 130 on which the workload 138 executes. For example, a workload 138 may have a label with a dimension “user group” and a value “managers.” Each workload 138 may be assigned labels for one or more dimensions but each workload 138 does not necessarily have a label assigned for every possible dimension. For example, a workload 138 may have a label specifying its location but may not necessarily have a label specifying its role. The set of labels assigned to a particular workload 138 may be referred to herein as a label set for the workload 138.

A logical management model specifying the number and types of dimensions available and those dimensions' possible values may be configurable. In one embodiment, the logical management model includes the following dimensions and possible values, as shown in Table 1:

TABLE 1
Example of logical management model

| Dimension | Meaning (M), Values (V) |
|---|---|
| Role | M: The role of the managed server within the |
| | administrative domain. |
| | V: web, API, database |
| Environment | M: The lifecycle stage of the managed server. |
| | V: production, staging, development |
| Application | M: The logical application (higher-level grouping |
| | of managed servers) to which the managed server |
| | belongs. |
| | V: trading, human resources |
| Line of Business | M: The business unit to which the managed |
| | server belongs. |
| | V: marketing, engineering |
| Location | M: The location of the managed server. Can be |
| | physical (e.g., country or geographical region) or |
| | logical (e.g., network). Physical is particularly |
| | useful for expressing geographic compliance |
| | requirements. |
| | V: US or EU (physical), us-west-1 or us-east-2 |
| | (logical) |
| User Group | M: The user group containing the user logged |
| | onto the managed server. |
| | V: Engineers, Contractors, Managers, System |
| | Administrators |

Workloads 138 may be logically grouped based on their respective label sets. An “application group” may be defined as a group of workloads 138 having the same label values for a predefined subset of label dimensions without necessarily having the same values in the other dimensions. For example, in one embodiment, an application group could be defined to include all workloads having the same label values in each of the “environment” and “application” dimensions. Alternatively, an application group could be defined to include all workloads having the same label values in each of the “environment,” “application” and “location” dimensions. A “tier” may be defined as a group of workloads 138 within an application group that have the same label value for at least one additional label dimension distinct from the label dimensions defining the application group. For example, a tier may be defined as group of workloads 138 having the same label values for the “environment,” “application,” and “role” labels. Alternatively, a “tier” may be defined as a group of workloads 138 having the same label values for the “environment,” “application,” “role,” and “location” dimensions. In some embodiments, the specific label dimensions used to define an application group and a tier may be configurable by an administrator.

The segmentation server 120 may use label sets to enable the network segmentation policy to be defined at a high level of abstraction by specifying policies based on label sets. Thus, a policy of the network segmentation policy may identify a group of workloads 138 to which a portion of the policy is applicable by referencing one or more label sets. For example, a policy may specify that a first group of workloads 138 with a label set A may provide a service B to a second group of workloads 138 with a label set C. Policies may be specified for groups of workloads 138 identified using only a subset of the label dimensions. For example, the network segmentation policy may specify policies that control communications between specified application groups or between specified tiers.

The segmentation server 120 may retain a repository storing information about the OS instances 130 and the workloads 138 managed by the segmentation server 120. For example, the segmentation server 120 may store, for each OS instance 130, an OS instance identifier that uniquely identifies the OS instance 130, workload identifiers for workloads 138 associated with the OS instance 130, and membership information indicating one or more groups of workloads 138 to which each workload 138 belong (e.g., as defined by the respective label sets for the workloads 138).

Table 2 illustrates an example of information stored by the segmentation server 120. Here, the “ID” represents the OS instance identifier for each OS instance 130. The workload ID(s) represent the workload identifier for the workload(s) 138 executing on each OS instance 130. If only a single workload executes on a particular OS instance 130, the workload ID may be synonymous with the OS instance ID (e.g., in the case of ID1 and IDn). If more than one workload 138 executes on a given OS instance 130, the workload ID may include the OS instance ID in combination with a sub-identifier for the workload 138 (e.g., in the case of ID2). The sub-identifier may comprise, for example, an IP address or other identifier that uniquely identifies the workload 138 when taken in combination with the identifier for the OS instance 130. The memberships represent groups to which one or more workloads 138 executing on the OS instance 130 belongs. Each group may correspond to a unique label set involving one or more dimensions (e.g., a combination of labels representing an application group, tier, or other group).

TABLE 2
Example of a Repository Table

| OS Instance ID | Workload ID(s) | Memberships |
|---|---|---|
| ID1 | ID1 | A, C, D |
| ID2 | ID2 + subID1 | B, C |
| | ID2 + subID2 | D |
| . | | . |
| . | | . |
| . | | . |
| IDn | IDn | B, D, E, F |

Instead of enforcing the network segmentation policy at a centralized device, the network segmentation policy is instead enforced by at least a subset of the OS instances 130. To enable enforcement of the network segmentation policy, the segmentation server 120 generates a set of management instructions and distributes the management instructions to the OS instances 130. The management instructions include the policies controlling communications between different groups of workloads 138 (e.g., specified by their label sets or directly by an identifier of the workload 138) and membership information indicating workloads 138 belonging to each group (e.g., which workloads 138 have certain label sets). For efficiency of distribution, the segmentation server 120 may send different management instructions to different OS instances 130 so that each OS instance 130 gets only the management instructions relevant to its operation. Here, the segmentation server 120 may determine which policies are relevant to a given OS instance 130 and distribute the relevant policies to that OS instance 130. A policy may be deemed relevant to a particular OS instance 130 if that OS instance 130 executes one or more workloads 138 that belongs to a group (defined by one or more label sets) referenced by the policy. The segmentation server 120 may furthermore determine which membership information is relevant to each OS instance 130 and distribute the relevant membership information to each respective OS instance 130. Here, membership information may be relevant to a particular OS instance 130 if it defines membership of a group referenced by a policy deemed relevant to the particular OS instance 130.

In various embodiments, the segmentation server 120 generates a visualization of the segmented network for display. The visualization may be displayed at the segmentation server 120 (e.g., on a screen) or provided to another computing device (e.g., the administrative client 160) for display.

The administrative client 160 comprises a computing device that may be operated by an administrator of the administrative domain 150 being managed by the segmentation server 120. The administrative client 160 may execute an interface (e.g., via an application or web browser) that enables the administrator to interact with the segmentation server 120 to configure or view the network segmentation policy and view visualizations of the network. The interface may furthermore enable the administrator to obtain various information about the OS instances 130 and workloads 138 on the network 110 and view traffic flows between the workloads 138.

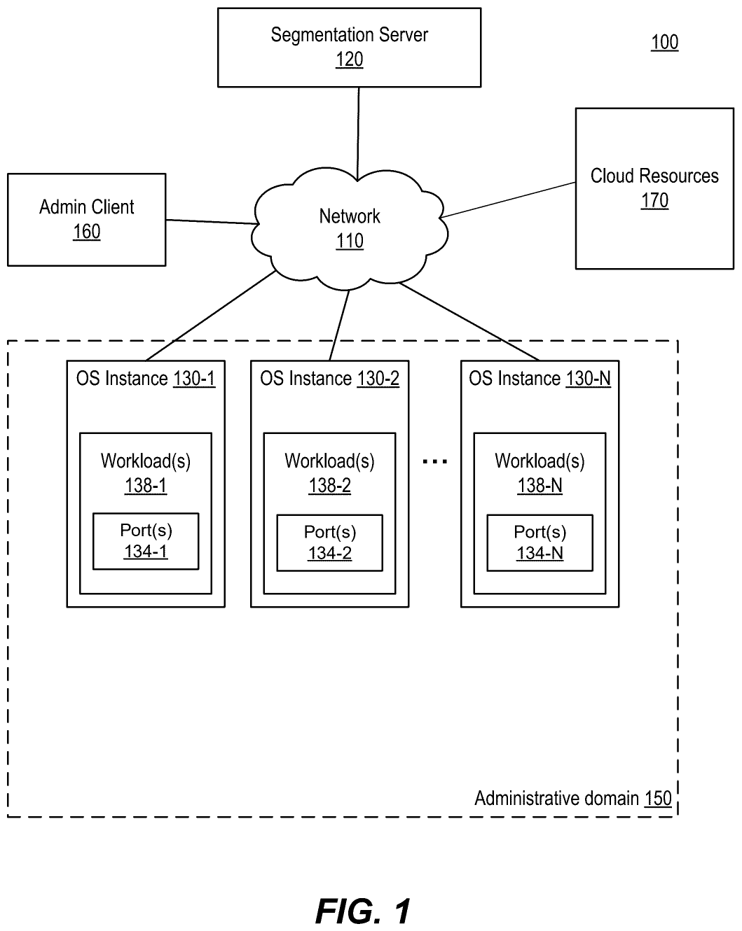

FIG. 2 illustrates example embodiments of OS instances 130. An OS instance 130 may correspond to a managed OS instance 230 or an unmanaged OS instance 240. A managed OS instance 230 includes an enforcement module 235 that enables the managed OS instance 230 to enforce the network segmentation policy for the workloads 138 it executes. In contrast, the unmanaged OS instance 240 does not include an enforcement module 235 and is unable to directly contribute to enforcement of the network segmentation policy. The segmentation server 120 thus only distributes management instructions to the managed OS instances 230. Nevertheless, the unmanaged OS instances 240 may still be affected by the network segmentation policy because the managed OS instances 230 may limit communications of its workloads 138 with workloads 138 on the unmanaged OS instance 240. Workloads 138 executing on the unmanaged OS instances 240 may be assigned labels and may be referenced in the policies of the network segmentation policy in the same way as workloads 138 on managed OS instances 130. Thus, communications between workloads 138 on managed OS instances 230 and unmanaged OS instances 240 may be controlled by the network segmentation policy by enforcing the policies at the managed OS instances 230.

In some embodiments, the network segmentation policy may be effectively enforced on an unmanaged OS instance 240 by a separate device that can control communications to and from the unmanaged OS instance 240 on which workloads 138 execute. For example, an enforcement module 235 on an upstream switch port or other device may control communications to and from workloads 138 on a downstream unmanaged OS instance 240. In this case, the network segmentation policy can be enforced directly on the workloads 138 on an unmanaged OS instance 240 similarly to enforcement on a managed OS instance 230.

The enforcement module 235 includes a management module 232, a management module configuration 234, and a policy implementation module 236. The management module 232 comprises a low-level network or security engine that controls incoming and outgoing traffic associated with each of the workloads 138 executing on the OS instance 130. For example, the management module 232 may include an operating system-level firewall, an Internet Protocol security (IPsec) engine, or a network traffic filtering engine (e.g., based on the Windows Filtering Platform (WFP) development platform). The management module 132 on a given managed OS instance 230 restricts communications to or from the workloads 138 executing on the given managed OS instances 230 based on the management module configuration. For example, the management module 232 may permit a particular workload 138 to communicate with a limited set of workloads 138 on other OS instances 130, and may block all other communications. Furthermore, the management module 232 may place restrictions on how each workload 138 is permitted to communicate. For example, for a particular workload 138, the management module 232 may enable the workload 138 to communicate using only encrypted protocols and block any unencrypted communications.

The policy implementation module 236 receives the management instructions from the segmentation server 120 and translates the management instructions from a high level of abstraction to a low level of abstraction represented by the management module configuration 234. For example, the policy implementation module 236 may obtain the relevant policies and relevant membership information from the management instructions, and identify the specific workloads 138 and services controlled by the policies. The policy implementation module 236 then generates a management module configuration 234 that enables the management module 232 to enforce the management instructions.

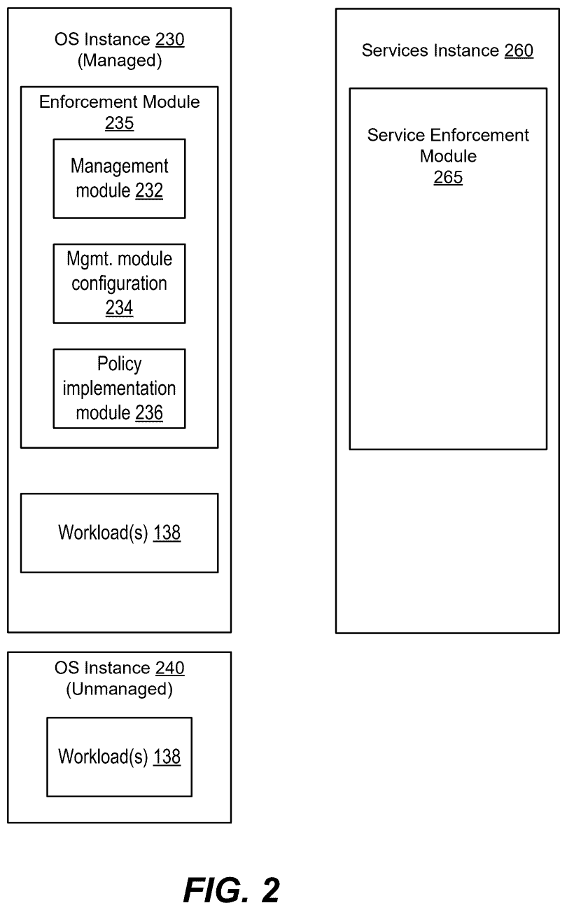

FIG. 3 illustrates one embodiment of the segmentation server 120. In the embodiment shown, the segmentation server 120 includes a segmentation graph module 302, a traffic flow module 304, a policy generation module 310, an instruction distribution module 312, a cloud security module 314, and a repository 350. The repository 350 may include a workloads database 352 that stores associations between workloads 138 and their respective label sets and a policy database that stores a network segmentation policy as a set of policies. In alternative embodiments, the segmentation server 120 may include different or additional components. The various components of the segmentation server 120 may be implemented as one or more processors and a non-transitory computer-readable storage medium that stores instructions executed by the one or more processors to carry out the functions attributed to the segmentation server 120 described herein.

The network segmentation policy graph module 302 generates a network segmentation policy graph comprising a data structure representing the permitted (but not necessarily observed) connections between workloads 138 under the network segmentation policy. In the network segmentation policy graph, each workload 138 is represented by a node and permitted connections between workloads 138 are represented by edges between the respective nodes. The nodes may store information relating to the workloads 138 and the edges may store information relating to the permitted traffic between the workloads such as the permitted port numbers, protocols, and services permitted between the workloads 138.

The network segmentation policy graph module 302 may generate a network segmentation policy graph that is limited to workloads within the scope of a specified label set. For example, the network segmentation policy graph module 302 may generate a network segmentation policy graph for a specific application group that is limited to policies affecting workloads 138 in the application group or may generate a network segmentation policy graph for a specific tier that is limited to policies affecting workloads 138 within the specified tier.

The network segmentation policy graph module 302 may furthermore generate segmentation policy graphs at different levels of abstraction. For example, the network segmentation policy graph module 302 may generate a tier-level segmentation policy graph in which tiers of workloads 138 are represented as nodes and a permitted connection between one or more pairs of workloads 138 in different tiers are represented as edges between the nodes. In this representation, an edge exists between a first tier and a second tier if a policy permits a connection between any workload 138 in the first tier and any workload 138 in the second tier. Similarly, the network segmentation policy graph module 302 may generate an application-level segmentation policy graph in which application groups are represented as nodes and a permitted connection between one or more pairs of workloads 138 in different application groups are represented as edges between the nodes. In this representation, an edge exists between a first application group and a second application group if a policy permits a connection between any workload 138 in the first application group and any workload 138 in the second application group.

The traffic flow module 304 monitors traffic between workloads 138 and presents information relating to the traffic flows. For example, the traffic flow module 304 may identify each pair of workloads 138 that communicate with each other during a particular time period. For each detected traffic flow between a pair of workloads 138, the traffic flow module 304 may identify what services are communicated between the pair of workloads 138 and the corresponding ports 134 and protocols used in the communications. Furthermore, the traffic flow module 304 may identify statistical information relating to the traffic flow between a pair of workloads 138 such as, for example, a volume of data transferred between the pair of workloads within a particular time period, a frequency of communications between the pair of workloads 138, a duration of communications between the pair of workloads 138, or other statistical information indicative of the extent of the communications. For the purpose of monitoring the traffic flows, the traffic flow module 304 may operate under a very permissive segmentation policy (e.g., enabling all workloads 138 in the administrative to communicate with all workloads 138 over all ports and protocols) so that the traffic flows are representative of the normal operation of the workloads 138 in the administrative domain 150.

The traffic flow module 304 may generate a data structure representing the traffic flows in the form of a traffic flow graph in which each workload 138 is represented by a node and a traffic flow between a pair of workloads 138 is represented by an edge connecting the respective nodes corresponding to the connected pair of workloads 138. The nodes may store information relating to the workloads 138 and the edges may store information relating to the traffic flow such as the port number, service, process, protocol, or combination thereof associated with the traffic flow. In an embodiment, the traffic flow graph may be limited to traffic flows meeting predefined criteria. For example, the traffic flow graph may be limited to traffic flows meeting a predefined threshold volume of the traffic (e.g., amount of data, frequency, duration, or a combination thereof). Thus, pairs of workloads 138 having only very limited or sporadic communications may be omitted from the traffic flow graph.

The traffic flow module 304 may generate a traffic flow graph that is limited to workloads within the scope of a specified label set. For example, the traffic flow module 304 may generate a traffic flow graph for a specific application group that is limited to traffic flows involving workloads 138 in the application group. In another example, the traffic flow module 304 may generate a traffic flow graph for a specific tier that is limited to traffic flows involving workloads 138 within the specified tier.

The traffic flow module 304 may furthermore generate traffic flow graphs at different levels of abstraction. For example, the traffic flow module 304 may generate a tier-level traffic flow graph in which tiers of workloads 138 are represented as nodes and an observed connection between one or more pairs of workloads 138 in different tiers are represented as edges between the nodes. In this representation, a first tier is considered connected to a second tier if a traffic flow is observed between any workload 138 in the first tier and any workload 138 in the second tier. Similarly, the traffic flow module 304 may generate an application-level traffic flow graph in which application groups are represented as nodes and an observed connection between one or more pairs of workloads 138 in different application groups are represented as edges between the nodes. In this representation, a first application group is considered “connected” to a second application group if a traffic flow is observed between any workload 138 in the first application group and any workload 138 in the second application group.

The edges in a traffic flow graph and a network segmentation policy graph may overlap to varying degree depending on how permissive the network segmentation policy. For example, in a highly permissive segmentation policy, the number of edges in the network segmentation policy graph may be significantly more than the number of edges in the traffic flow graph because only a subset of the permitted connections are actually utilized by the workloads 138. In a less permissive segmentation policy, the number of edges in the network segmentation policy graph may be similar to or the same as the number of edges in the traffic flow graph because the network segmentation policy only permits traffic close to that observed.

The policy generation module 310 automatically generates or updates a network segmentation policy comprising a set of policies. The particular strategy for generating the policies may be based on configuration settings, the observed traffic graph, known or detected vulnerabilities, or a combination thereof. In general, the policy generation module 310 generates policies that when enforced will allow at least the traffic flows in the traffic flow graph. The policies may also allow traffic flow beyond that specifically observed in the traffic flow graph depending on the control level of permissiveness specified in the configuration settings and any known of identified vulnerabilities. For example, the policy generation module 310 may generate the most permissive policies allowed by the configuration settings that do not unnecessarily expose an identified vulnerability. Generating policies based on the observed traffic flow graph is beneficial because, assuming that there are no abnormal or malicious communications in the administrative domain 150 in the observed traffic flow graph, the policy generation module 310 can produce a set of policies that permits communications observed during normal operation of the workloads 138 in the administrative domain 150 while blocking or limiting abnormal communications that are potentially malicious. Furthermore, by limiting policies based on the discovered vulnerabilities, the policy generation module 310 may reduce the exposure to a known vulnerability by limiting overly permissive policies.

The policy generation module 310 may generate policies based on different segmentation strategies depending on configuration parameters. For example, under a port-level granularity segmentation strategy, the policy generation module 310 generates a set of policies that only permits communications between pairs of workloads 138 using the specific ports and protocols observed in the traffic flows. Thus, for example, if the traffic flow module 304 only observes communications between a first workload W1 and a second workload W2 using port P, a policy will be generated that permits communications between the first workload W1 and the second workload W2 only over port P without permitting communications over other ports. In an embodiment, the generated policy may be specified to apply to particular groups of workloads 138 in which the respective workloads in the pair have memberships. For example, the policy may specified in accordance with respective label sets of the pair of workloads along a predefined set of dimensions (e.g., the dimensions defining a tier). As a result, the policy will also permit communications conforming to the specified ports and protocols between different pairs of workloads that conform to the same respective label sets along the same predefined set of dimensions (e.g., the same respective tiers) as the observed pair of workloads. For example, a policy may be generated that permits workloads 138 in a first tier associated with the label set “App: Point of Sale; Environment: PCI; Role: Database” to provide a service on port 5432 using TCP protocol to workloads 138 in a second tier associated with the label set “App: Point of Sale: Environment: PCI; Role: Processing.”

In a workload-level granularity segmentation strategy, the policy generation module 310 generates policies that enable communications between groups of workloads 138 that are observed as being connected in the traffic flow graph, without limiting the policies to specific ports or protocols. For example, if a connection is observed between a workload 138 in a first group of workloads 138 and a workload 138 in a second group of workloads 138, a policy is generated to permit communications between workloads 138 in the first group and workloads in the second group. Here, the group to which the policy generating applies may be preconfigured and may be based on a label set along a predefined set of dimensions. For example, under one configuration, this strategy may generate a policy may that permits workloads 138 in a first tier associated with the label set “App: Point of Sale; Environment: PCI; Role: Database” to provide any service (using any port and any protocol) to workloads 138 in a second tier associated with the label set “App: Point of Sale: Environment: PCI; Role: Processing” if any traffic flows are observed between the first and second tier in the traffic flow graph. Upon enforcement of the network segmentation policy, communications between pairs of workloads that are not expressly permitted by the policies will be blocked.

Under other configuration settings, the policy generation module 310 may generate policies that permit communications between certain specified groups of workloads 138 (e.g., based on the label sets) independently of the observed traffic flows. For example, in a group-level granularity segmentation strategy, the policy generation module 310 generates a set of policies that permits communications between all workloads 135 in a predefined group (e.g., share a set of labels along a predefined set of dimensions) without regard to observed communications. For example, the policy generation module 310 may generate policies that permit communications between all workloads 138 within the same application group. For example, a policy may be generated that permits workloads 138 in an application group associated with the label set “App: Point of Sale; Environment: PCI” to provide any service (using any port and any protocol) to other workloads 138 in the application group. Upon enforcement of the network segmentation policy, communications between pairs of workloads that are not expressly permitted by the policies will be blocked.

In another embodiment, configuration settings may cause the policy generation module 310 to generate policies permitting communications between specified groups of workloads 138. For example, under certain configuration settings, the policy generation module 310 may generate policies permitting communications between a first application group A1 and a second application group A2.

In an embodiment, policies may be generated differently for different groups of workloads 138 by specifying different configuration settings for different groups. For example, policies may be generated for workloads 138 in a first application group according to a workload-level granularity segmentation strategy while policies may be generated for workloads 138 in a second application group according to a port-level granularity segmentation strategy. Furthermore, policies controlling communications between different groups of workloads 138 may be generated according to different configuration settings. For example, policies controlling communications between workloads 138 in a first application group and workloads 138 in a second application group may be generated according to a workload-level granularity segmentation strategy while policies controlling communications between workloads 138 in a first application group and workloads 138 in a third application group may be generated according to a group-level granularity segmentation strategy.

In other embodiments, a segmentation strategy may be applied to generate policies in which workloads 138 are permitted to provide services according to a first segmentation strategy and are permitted to use services according to second segmentation strategy. For example, a segmentation strategy may generate policies that enable workloads 138 to provide services to any workloads 138 within an application group without regard to specific port or protocol (e.g., consistent with a group-level granularity segmentation strategy), but only enables workloads 138 to use services consistent with the ports and protocols in the observed traffic graph (consistent with a port-level granularity segmentation strategy).

In yet other embodiments, other variations of segmentation strategies or combinations thereof may be applied that do not necessarily conform to the port-level granularity, workload-level granularity, or group-level granularity strategies described above or the variations thereof discussed above.

The policy generation module 310 may modify an initial segmentation strategy based on new information (e.g., newly identified vulnerabilities) to reduce the number of permitted connections that may expose the administrative domain 150 to a vulnerability. If a network segmentation policy enables communication over a vulnerable port, the segmentation strategy may be modified so that the resulting segmentation policy limits the permitted communications on the vulnerable port based on the observed traffic flow graph.

The instruction distribution module 312 generates the management instructions from the policies for a current segmentation policy and distributes the relevant management instructions to the OS instances 130 as described above. In an embodiment, the instruction distribution module 312 generates and distributes the relevant management instructions to the OS instances 130 upon approval from an administrator. Alternatively, the instruction distribution module 312 may automatically distribute the instructions upon being generated without necessarily requiring an additional approval.

The cloud security module 314 analyzes, manages and enforces segmentation policies in the networked computing environment 100. The cloud security module 314 may be configured with one or more functions for managing security within the cloud computing environment. In one embodiment, the cloud security module 314 may generate contextual relationships between cloud application instances to determine the segmentation policies to be enforced in cloud security controls. The cloud security module 314 may also investigate current and historical attack scenarios based on cloud metadata and contextual relationships. In another embodiment, the cloud security module 314 may automate policy management using cloud context and flows. The cloud security module 314 may also automate the enforcement of segmentation policies in a new account on its creation in an onboarding cloud computing environment. Furthermore, the cloud security module 314 may use cloud metadata to determine application components and their deployment environment to assign and enforce segmentation policies via cloud security controls, automatically in an application instance.

In some embodiments, the cloud security module 314 is configured to collect cloud metadata from enterprises' cloud computing environment and store it in a metadata storage. The cloud security module 314 is also configured to retrieve other relevant information including but not limited to flows to enforce segmentation. With the ability to gather relationship context for security controls and their attachment, the cloud security module 312 not only determines which security control protects that resource but can also determine which policy should be enforced at which level of security control, to achieve maximum protection in the most effective manner.

In some embodiments, users can onboard their diverse cloud accounts, such as AWS, Azure, GCP and OCI. The cloud security module 314 may include a built-in wizard that guides users through onboarding. For each cloud account type, the cloud security module 314 may supply users with a pre-populated CloudFormation template, Terraform or PowerShell script, setting up all requisite identity and access management (IM) roles and permissions or creating application registration and permissions. Once onboarding is completed, the cloud security module 314 is able to automatically “learn” about the cloud computing environments based on metadata associated with resources, identifying workloads, and gathering traffic flow data.

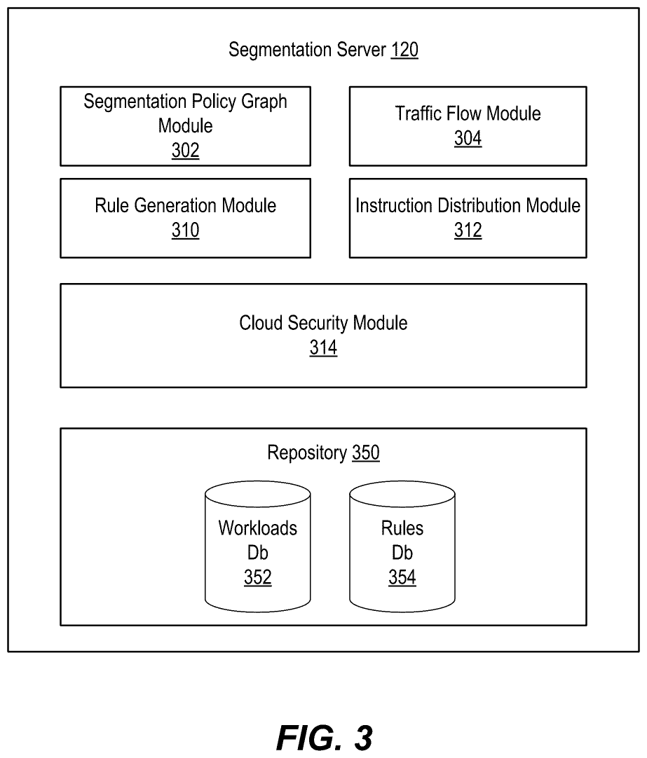

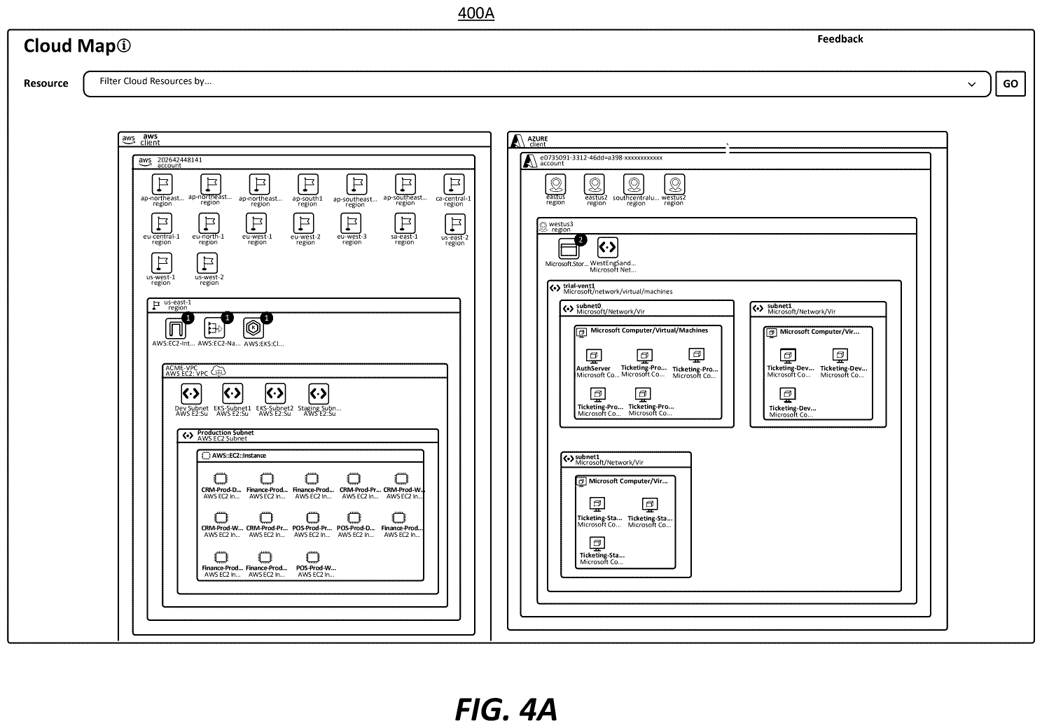

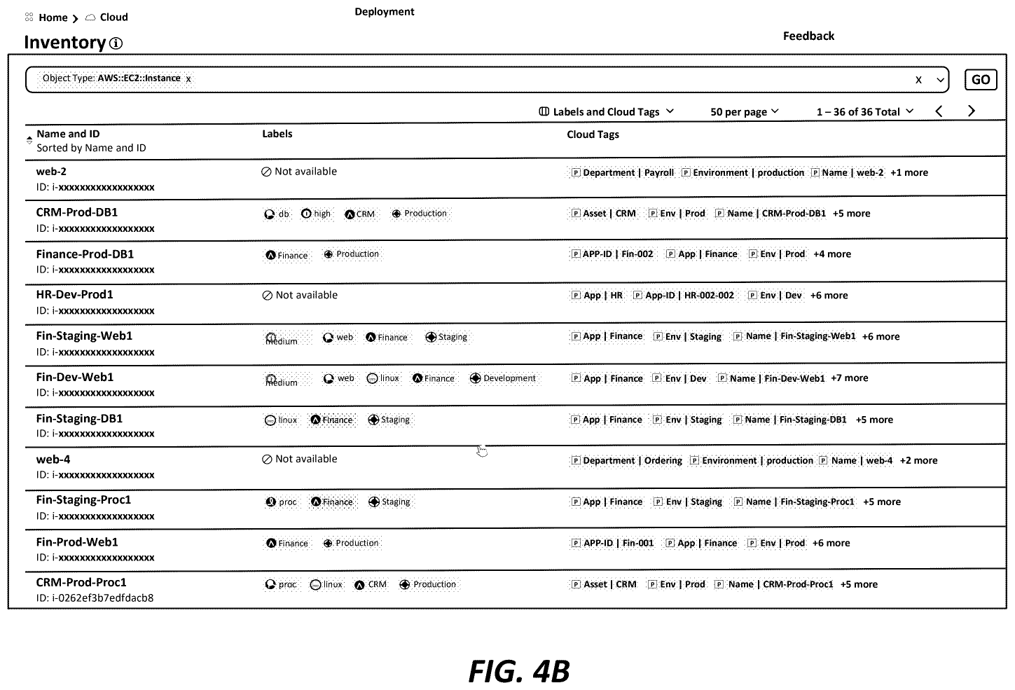

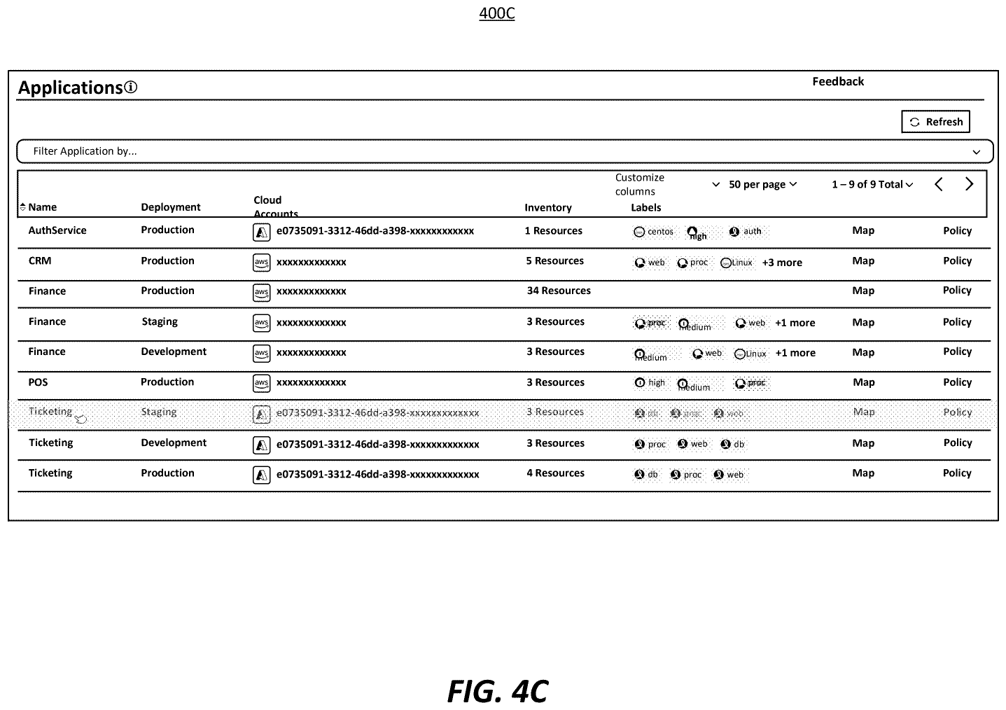

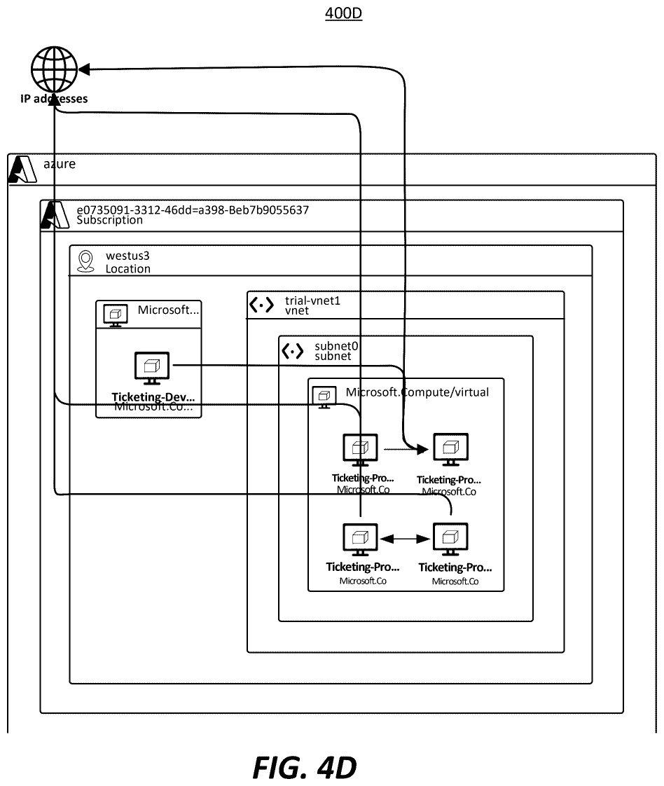

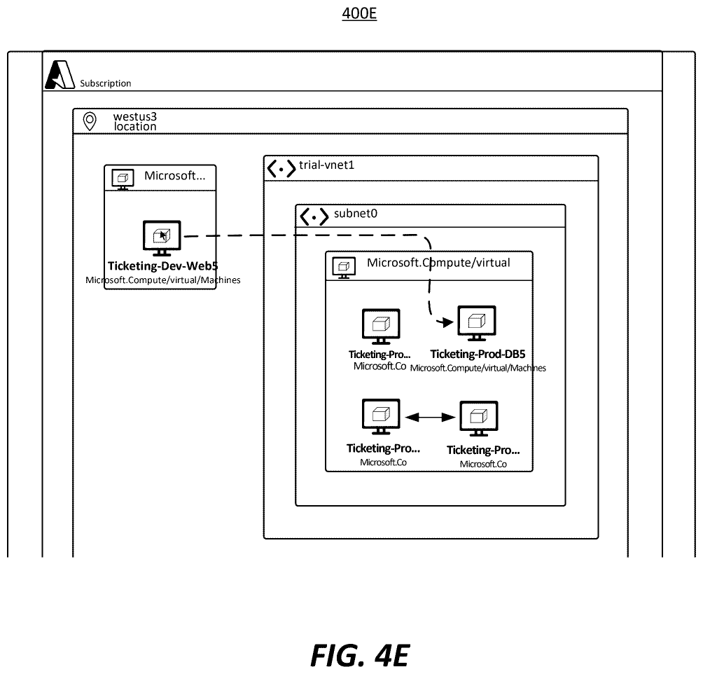

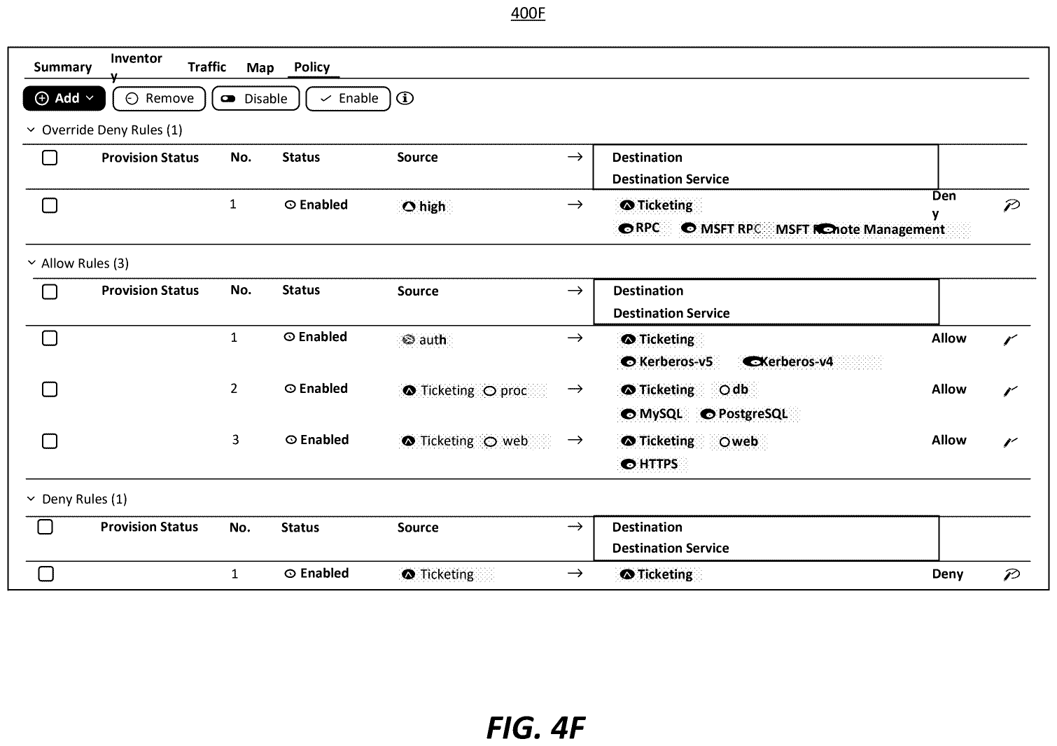

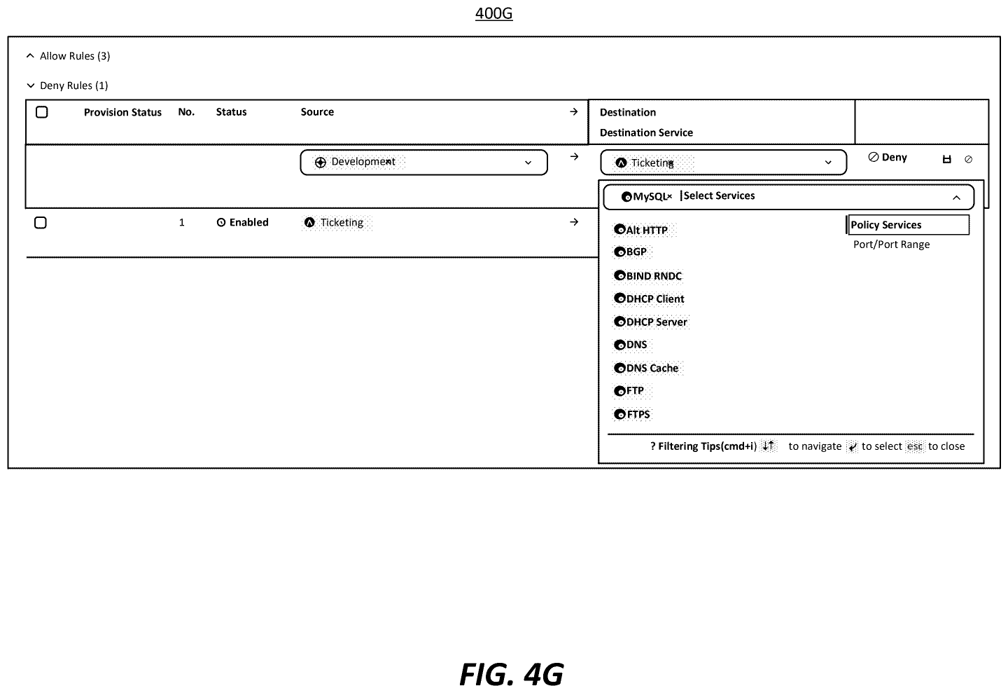

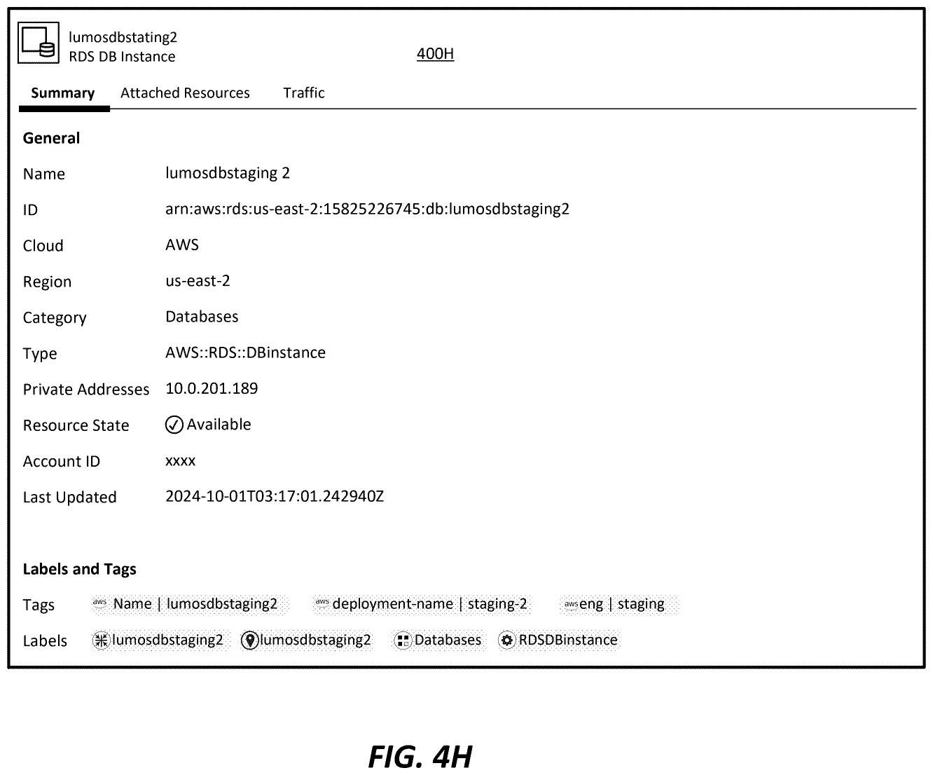

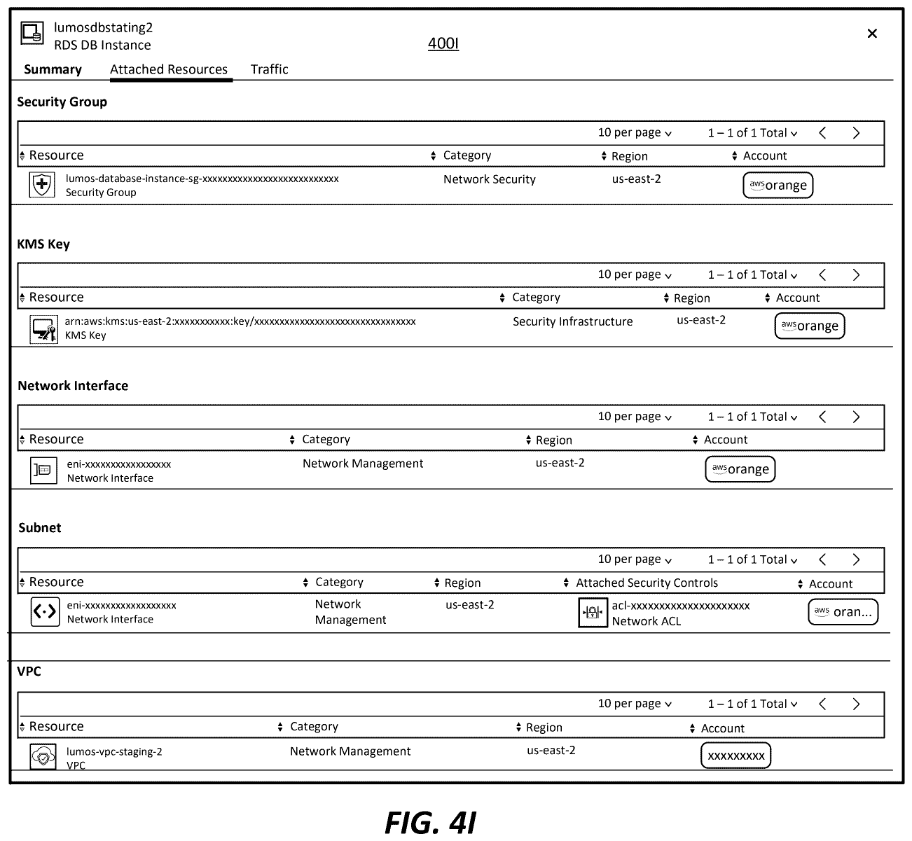

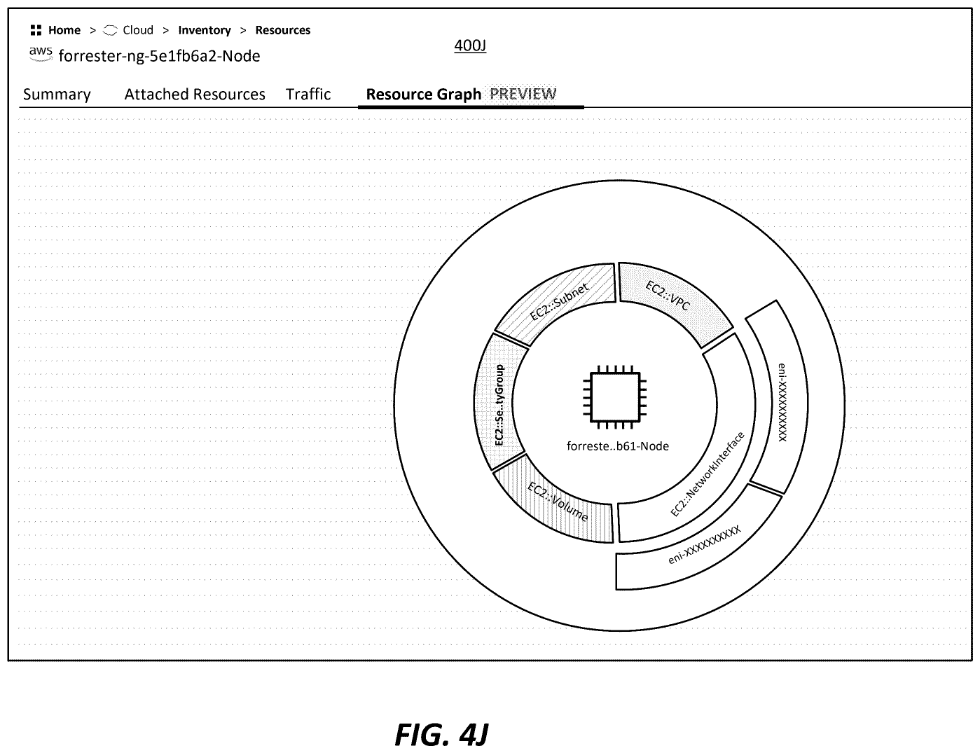

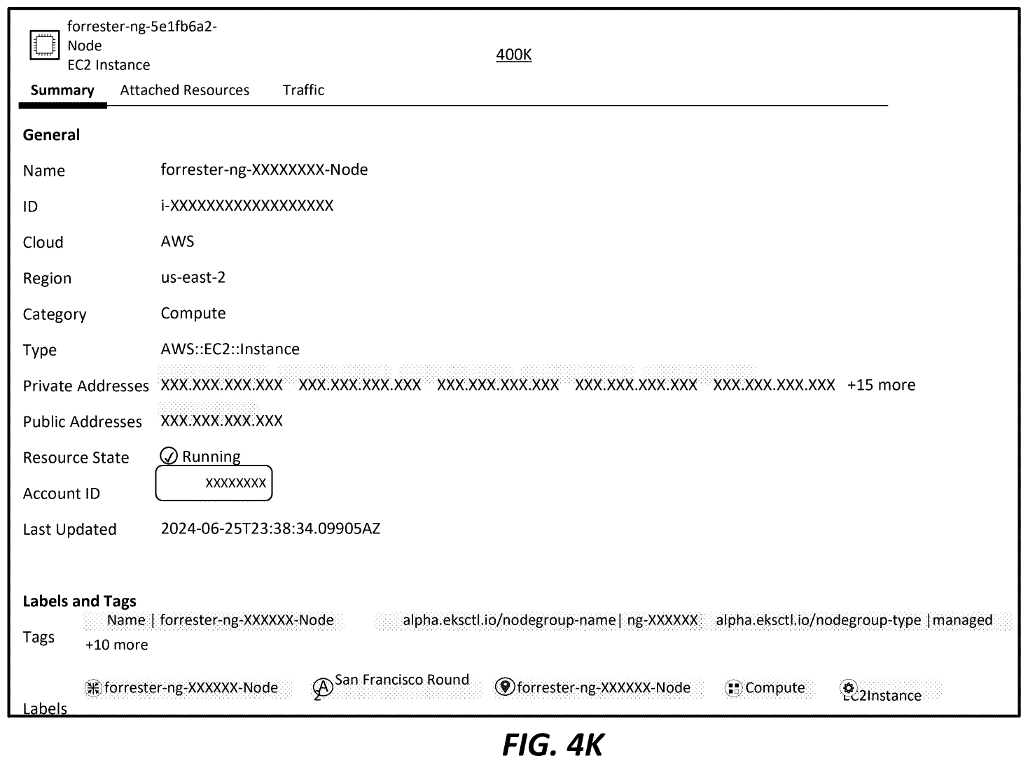

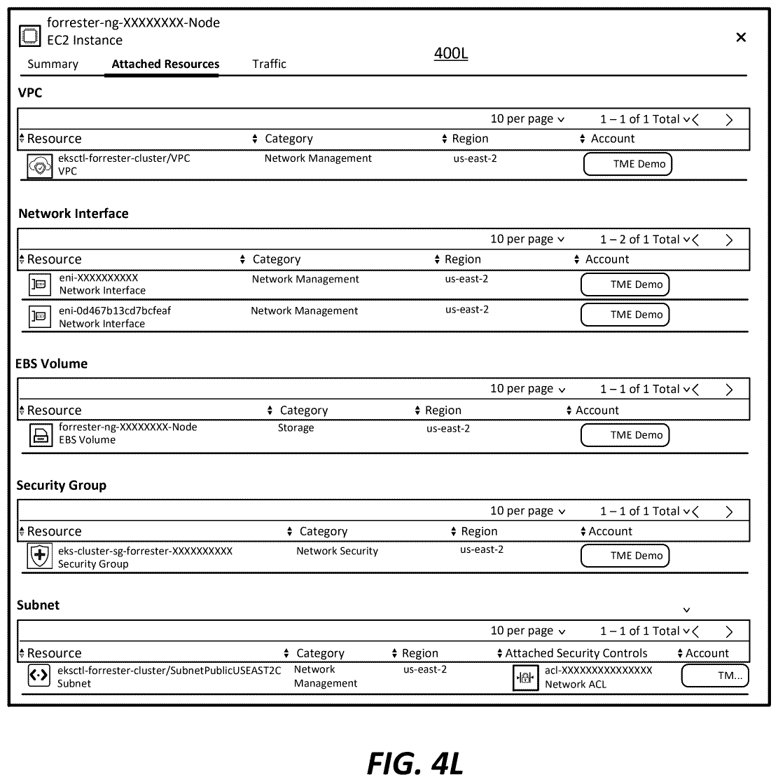

In some embodiments, the cloud security module 314 is configured to create resource mapping and visualization of such mapping. FIG. 4A illustrates an example graphical user interface (GUI) 400A that visualizes different resources in different cloud accounts associated with an enterprise in accordance with one or more embodiments. The left side of the GUI 400A shows resources associated with an AWS account, and the right side of the GUI 400A shows resources associated with an Azure account. These resources may be across different regions and presented in a hierarchy. For instance, within the US East 1 region, NAT gateways, VPCs, subnets, and individual VMs are shown in the GUI 400A. The visualization enables enterprise users to understand resources in their cloud computing environment and their communication channels before configuring segmentation policies (such as SGs, NACL, Security Lists and/or firewalls) to enhance control.

FIG. 4B illustrates an example GUI 400B that visualizes a list view of all resources within a cloud computing environment in accordance with one or more embodiments.

In some embodiments, the cloud security module 314 is also configured to discover applications deployed in a cloud computing environment and visualize the discovered applications. In some embodiments, the cloud security module 314 can automatically discover applications deployed in a cloud computing environment based on certain rules based on cloud metadata, and visualize the discovered applications. FIG. 4C illustrates an example GUI 400C that visualizes discovered applications in a cloud computing environment. As depicted, the cloud computing environment includes a finance application and a ticketing application, among others. There may be different deployments where those applications are rolled out. There may also be different instances of a same application, such as a production instance and/or a development instance. The cloud security module 314 automatically assigns labels to different deployments of applications. Users can also create segmentation policies at an application level.

For each application, a map view may be presented that just shows resources related to a particular application. If a particular communication shown in the map view does not seem to be correct, a user can generate a rule to deny such a communication channel. FIG. 4D illustrates an example GUI 400D that visualizes a map view of an application in accordance with one or more embodiments. The arrow lines indicate communications and the directions they took between resources.

In some embodiments, a user can select a particular cloud resource (e.g., by hovering over that cloud resource), causing the cloud security module 314 to display inbound and outbound traffic flows from the selected cloud resource. FIG. 4E illustrates an example GUI 400E that visualizes a view of traffic flow associated with a particular resource in accordance with one or more embodiments.

The segmentation policies between different resources in an application may also be visualized in a table view. FIG. 4F illustrates an example GUI 400F that visualizes a table view of the rules between different resources of an application in accordance with one or more embodiments. As illustrated, each rule is visualized as a line of data, including a source and a destination, indicating a direction of traffic flow. A rule may be a deny rule or an allow rule. A deny rule indicates that data traffic from the source to the destination is denied, and an allow rule indicates that data traffic from the source to the destination is allowed.

In some embodiments, the cloud security module 314 can be configured with rules to label each resource with a tag based on its metadata. These rules can be broad and pre-defined before discovering the cloud resources or narrow and defined with specific criteria after discovering the cloud resources. The tags are human-readable and intuitive to users. The tags enable the cloud security model 314 to generate segmentation policies automatically to allow or curtail network traffic between particular resources. FIG. 4G illustrates an example GUI 400G that allows a user to create a deny rule or an allow rule by simply selecting a tag for a source resource and a tag for a destination resource in accordance with one or more embodiments.

FIG. 4H illustrates an example GUI 400H displaying a detailed summary of a relational database service (RDS) database instance in accordance with one or more embodiments. The summary includes general information about the database instance, such as name of the RDS database instance, an ID, a cloud provider, a region, a category, a type, a private address, a resource state, an account ID, and a last updated timestamp. The summary also includes tags (e.g., name, deployment name, environment) and labels, which may correspond to the instance name, lumosdbstaging2, the instance type (e.g., RDSDBInstance), and the application type (e.g., Databases).

FIG. 4I illustrates an example GUI 4001 listing resources associated with an RDS database instance in accordance with one or more embodiments. The resources include security group, KMS key, network interface, subnet, and virtual private cloud (VPC).

FIG. 4J illustrates an example GUI 400J including a circular graph that visualizes resources associated with an RDS database instance and their relationships in accordance with one or more embodiments. The circular graph includes a central node, corresponding to a database instance. The circular graph also includes two rings surrounding the central node. The first ring surrounding the central node includes EC2-subnet, EC2-VPC, EC2-Volumne, EC2-NetworkInterface, each corresponding to a resource associated with the database instance. The second ring surrounding the first ring includes two identifiers which may correspond to identifiers of different network interfaces.

FIG. 4K illustrates an example GUI 400K displaying a detailed summary of a virtual machine (VM) instance in accordance with one or more embodiments. This summary includes general information about the VM instance, such as name, ID, cloud provider, region, category, private addresses, public addresses, resource state, account ID, and last updated timestamp. The summary also includes tags and labels as those shown in FIG. 4H.

FIG. 4L illustrates an example GUI 400L listing resources associated with a virtual machine (VM) instance in accordance with one or more embodiments. The resources includes VPC, network interface, elastic block store (EBC) volume, security group, and subnet.

FIG. 4M illustrates an example GUI 400M including a circular graph that visualizes resources for a VM instance and their relationships in accordance with one or more embodiments. The circular graph includes a central node, corresponding to a VM instance. The circular graph also includes a ring surrounding the central node. The ring includes EC2-VPC, EC2-Security group, KMS key, an EC2-network-interface, and EC2-subnet, each corresponding to a resource associated with the VM instance. This circular graph also shows connections to several other instances or resources represented by their identifiers.

The cloud security module 314 is configured to identify resources associated with the tags, determine a control level at which the security rule is to be enforced based on the resources associated with the security control, and generate segmentation policies based on the determined level of control.

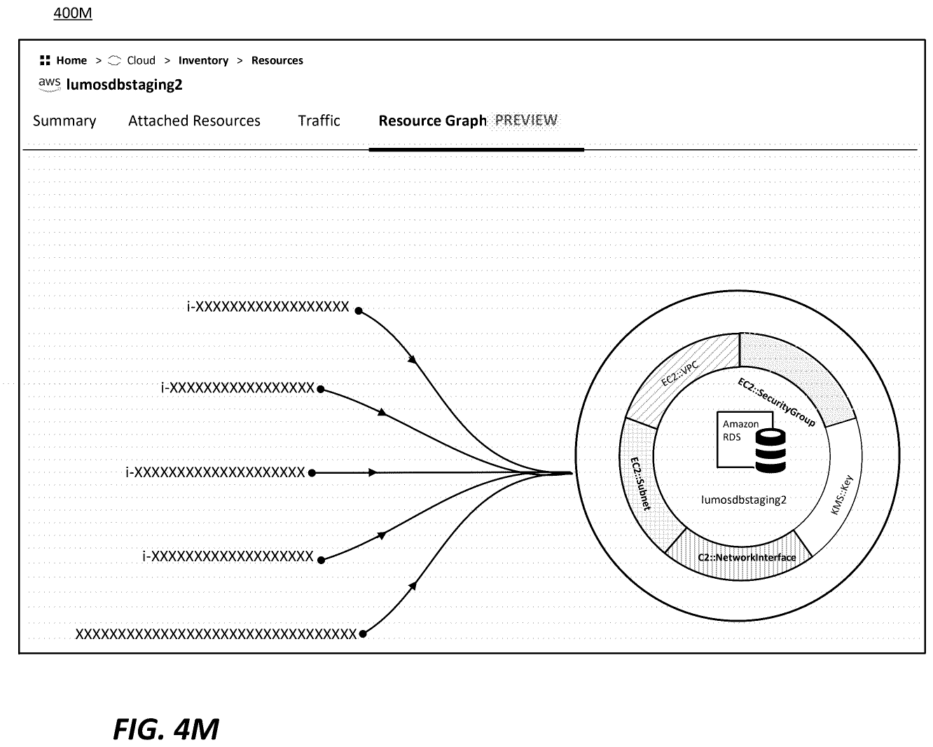

The cloud security module 314 may include one or more of the noted functionalities. Moreover, each functional aspect of the cloud security module 314 may be individually configured for operation within the cloud computing environment. Each of the functional configurations is further described below with respect to FIGS. 5-16.

### Instrumenting Contextual Relationships for Enforcing Segmentation in Cloud Security Controls

FIG. 5 illustrates an example environment 500 that includes a virtual machine instance (VM1) established in a public cloud in a particular region, such as AWS in an east US region. If the cloud computing environment only includes a single VM, a single segmentation policy, e.g., a single security group (SG1), is often required to be created and enforced. However, a typical enterprise may have rolled out 600 virtual machines (VMs) across ten regions. Assuming there is only one security group per VM, there would be 600 security controls that need to be overseen. If the same enterprise uses 600 VMs and 500 Platforms as a Service (PaaS) resources, each having two security groups, the total number of security controls that need to be managed escalates to 1600.

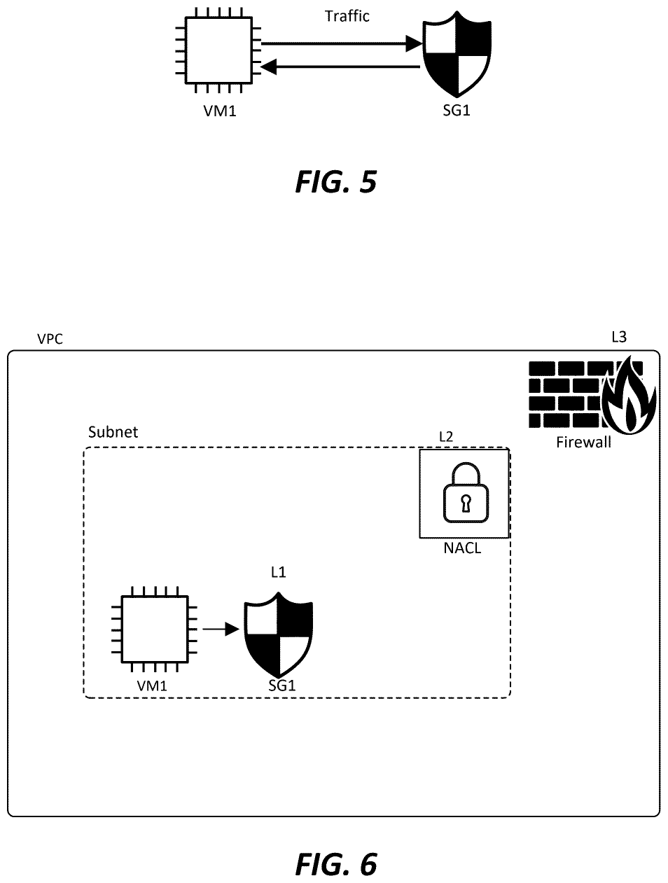

In some embodiments, an enterprise may implement multi-layer security. FIG. 6 illustrates an example environment 600 that includes a virtual machine (VM1) associated with multi-level control. The multi-level control includes a security group (SG1), which is a first-level (L1) control; an NACL, which is a second-level (L2) control; and a firewall, which is a third-level (L3) control. L1 typically refers to the first layer or level in a hierarchical structure or model, often implying the most fundamental level of control, categorization, or security in a given context. In the above-described scenarios, L1 likely signifies the base or primary level of security controls being applied, and L1 is often attached to individual resources. The second layer (L2) is attached at a level above resources typically to the network subnet, the third layer (L3) is attached at a level above L2 at the VPC/VNET, and so on. If the enterprise has about 1600 L1 controls, 400 L2 controls, and 5-10 L3 controls, the total number of security measures that need to be managed would be further escalated to several thousand. This is just managing a single cloud account, e.g., an AWS, Azure, GCP or OCI account. Imagine the complexity and scale of security management required for an enterprise with over 20 cloud accounts, e.g., 20 AWS accounts, 30 Azure accounts, 10 GCP and 15 OCI accounts with resources distributed over a dozen different regions.

Conventional network security systems or modules may allow administrators to manage network traffic based on segmentation policies manually. Administrators need to use a command line interface or software development kits (SDKs) to generate segmentation policies, which are highly complex, dynamic, technical and error-prone. However, the challenge escalates significantly when the number of controls reaches 2000 Beyond 2000, manually maintaining and updating the policies becomes nearly impractical. Even with a smaller number of controls, the challenge still exists if the environment is constantly evolving either in terms of changing identity of resources or changing traffic patterns.

The cloud security module 314 described herein solves the above-described problem by collecting metadata associated with resources in a cloud computing environment, identifying relationships among the resources based on the metadata, and building a data structure based on the identified relationships. This data structure can then be used to generate visual representation of the environment and also to generate segmentation policies automatically with or without user interventions.

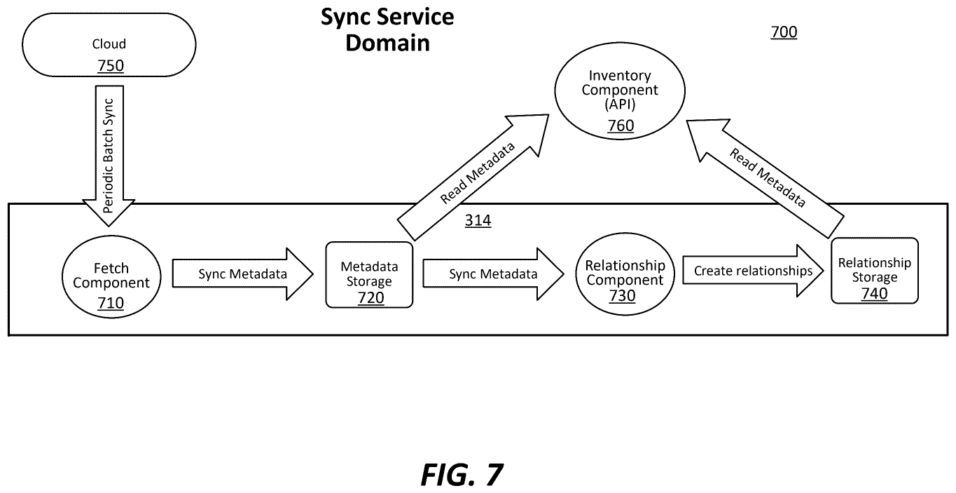

FIG. 7 illustrates an example of sync service domain 700, in which cloud security module 314 is configured to synchronize metadata about resources hosted at cloud services 750 and identify their relationships in accordance with one or more embodiments. The cloud security module 314 includes a fetch module 710, a metadata storage 720, a relationship module 730, and a relationship storage 740. The fetch module 710 is configured to fetch metadata from cloud service 750 (which hosts an enterprise's cloud computing environment) and store and sync the metadata in metadata storage 720. In some embodiments, the synchronization may be performed periodically, such as once an hour, once a day, once a week, etc. Alternatively, or in addition, the cloud security module 314 may utilize APIs offered by cloud services 750 to synchronize metadata in response to changes to cloud resources or even at periodic intervals.

The metadata is also sent and synchronized with the relationship module 730. The relationship module 730 is configured to analyze the metadata to determine relationships between resources based on the metadata. The metadata includes detailed attributes for all cloud resources including but not limited to various security controls associated with the cloud resources. The cloud service 750 may implement single-level security control or multi-level security control, and for a multi-level security control environment, each security control is associated with one of a plurality of levels. The determined relationships may then be stored in a relationship storage 740. In some embodiments, the cloud security module 314 labels cloud resources with different tags based on the associated metadata, and the relationships between resources are represented as relationships between different tags that label the cloud resources. In some embodiments, the cloud security module 314 will represent the relationships between resources as relationships between unique identifiers of the cloud resources

In some embodiments, the relationships are represented as a data structure, such as a table stored in a table database. Alternatively, the data structure may be a graph and stored in a graph database. The graph includes one or more core nodes and one or more leaf nodes, along with their associations and timestamps of when these relationships are valid. The relationship storage 740 may be configured to power various queries through an inventory API 760. For example, users (e.g., administrators of a cloud computing environment) can query segmentation policies associated with a particular resource, such as a VM, a subnet, or a VPC. Alternatively, or in addition, an administrator can query cloud resources or segmentation policies associated with one or more tags.

In some embodiments, to synchronize metadata of cloud resources, the cloud security module 314 is configured to traverse across network paths to determine relationships among cloud resources. For example, the cloud security module 314 identifies an enterprise in AWS and identifies one or more AWS accounts under the AWS enterprise. For each of the one or more AWS accounts, the cloud security module 314 identifies one or more VPCs under the AWS account. The security control of each VPC is a firewall. For each of the one or more VPCs, the cloud security module 314 identifies one or more subnets. The security control of each subnet is a NACL. For each of the one or more subnets, the cloud security module 314 identifies one or more VMs. The security control of each VM is a SG. The traversal from VPCs to subnets to VMs is a core-to-leaf node approach, and all the security controls that are attached at each level are also leaf nodes.

In some embodiments, the cloud security module 314 can traverse all VMs. Each VM may be associated with a VPC controlled by a firewall. Each VPC may include one or more subnets, each of which is controlled by an NACL. Each subnet may include one or more serverless functions, each of which is controlled by an SG.

In some embodiments, the cloud security module 314 maps security groups to resources that they are protecting. In this case, security groups become core nodes, and VMs become leaf nodes in the graph. In some embodiments, the security groups become leaf nodes for a VPC. In some embodiments, elastic network interfaces (ENIs) are leaf nodes, and VMs become core nodes for their attached ENIs. In some embodiments, IP addresses are leaf nodes, and the ENIs become core nodes for the associated IP addresses. In some embodiments, the graph may be visualized in a GUI. Referring back to FIG. 4A, GUI 400A depicts a hierarchical relationship among different cloud resources.

There can be multiple security controls at each level, and the same applies to the core nodes as well. The relationship graph can expand to multiple cores and multiple nodes at any point in a traversal path. This path can be used to determine multiple outcomes, such as where an effective segmentation policy should be used to achieve a desired outcome, and for a given traffic scenario, the cloud security module 314 determines whether it will be successful with the existing policies in all the security controls on the path.

Using the security control and network information gathered in the graph database and metadata database, the cloud security module 314 can determine what policy needs to be written to enforce segmentation. Since the information is obtained across various security control levels, the cloud security module 314 can analyze complete traffic paths to determine stale security controls and security vulnerabilities and/or write enhanced rules and policies based on the enterprise's security needs. In some embodiments, the traffic paths can also be visualized in a GUI. Referring back to FIG. 4D, GUI 400D depicts traffic paths among different cloud resources.

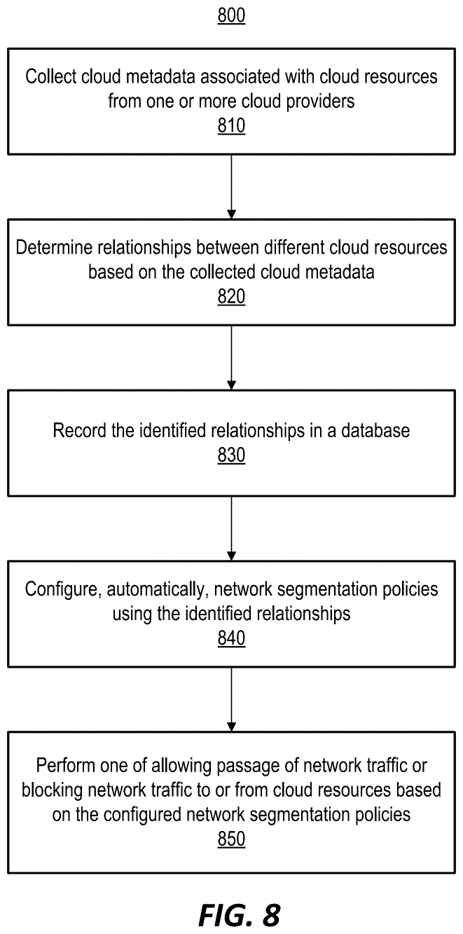

FIG. 8 is a flowchart of an example method 800 for configuring network segmentation policies in accordance with one or more embodiments. Alternative embodiments may include more, fewer, or different steps from those illustrated in FIG. 8, and the steps may be performed in a different order from those illustrated in FIG. 8. The method 800 may be performed by the network security module 314 of FIG. 3.

In the embodiment shown in FIG. 8, the method 800 begins with the network security module 314 collecting 810 cloud metadata associated with cloud resources from one or more cloud providers. The one or more cloud providers may include (but are not limited to) AWS, Azure, OCI and/or GCP. The cloud resources may be associated with a particular enterprise or multiple enterprises.

The cloud security module 314 determines 820 relationships between different cloud resources based on the collected cloud metadata. The relationships may help determine whether traffic is allowed (1) from a first resource to a second resource but not the other direction, (2) from the second resource to the first resource but not the other direction, and/or (3) between the first resource and the second resource. In some embodiments, the relationships may be represented by a graph. The cloud security module 314 stores 830 the identified relationships in a database, which may be a graph database. In some embodiments, the cloud security module 314 automatically configures 840 network segmentation policies using the identified relationships stored in the database and the cloud security control performs 850 one of allowing passage of network traffic or blocking network traffic to or from cloud resources based on the configured network segmentation policies.

In some embodiments, the cloud security module 314 visualizes the identified relationships among resources and traffic flows between resources in a GUI, (e.g., GUIs 400A-F). For example, an arrow may be linked from a source resource to a destination resource, indicating a direction of network traffic. In some embodiments, a user may add or delete a security rule by interacting with the GUI. For example, a user can click an arrow between two resources indicating a source resource and destination resource and whether network traffic from the source and destination resources will be allowed or rejected. The security rule may be input as a natural language sentence in some embodiments. In some embodiments, the rule can also be defined using labels or tags that are associated with the resources.

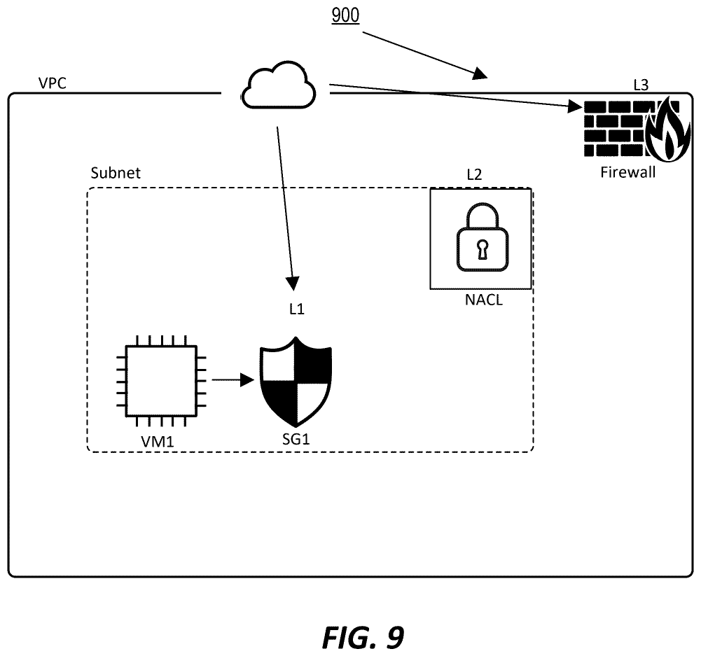

Based on the security rule, the cloud security module 314 identifies cloud resources associated with the security rule and determines a control level at which the security rule is to be enforced based on resources for which the security rule is applicable. FIG. 9 illustrates an example of a virtual private cloud computing environment 900, including three levels of controls. For example, if a secure shell (SSH) is to be allowed to access a VM, a user may create a security rule to allow such traffic. Responsive to receiving the security rule, the cloud security module 314 identifies the resources for which the security rule is applicable and determines a control level at which the security rule is to be enforced based on the resources associated with the security rule. Here, the resource associated with the security rule is a VM (denoted VM1), and the cloud security module 314 determines that the security rule is to be enforced at a first level (L1). Thus, an SG (denoted SG1) is automatically created.

As another example, if all VMs in a subnet should be denied by a polling service, an administrator creates a security rule to deny such traffic. The cloud security module 314 identifies the cloud resources for which the security rule is applicable and determines a control level at which the security rule is to be enforced based on the identified resources. Here, the control level is a second level (L2). Thus, the cloud security module 314 creates a network segmentation policy at a second layer, e.g., automatically creating a NACL policy, and the NACL will deny all VMs in the subnet to be reached by the polling service. Again, if all VMs in a VPC should be denied access to the Internet, an administrator creates a security rule to deny such traffic. The cloud security module 314 determines the control level at which the security rule is to be enforced. Here, the control level is a third level. Thus, the cloud security module 314 creates a network segmentation policy in the third layer, e.g., automatically creating a firewall rule, and the firewall will deny anything from the Internet to reach all the VMs in the VPC.

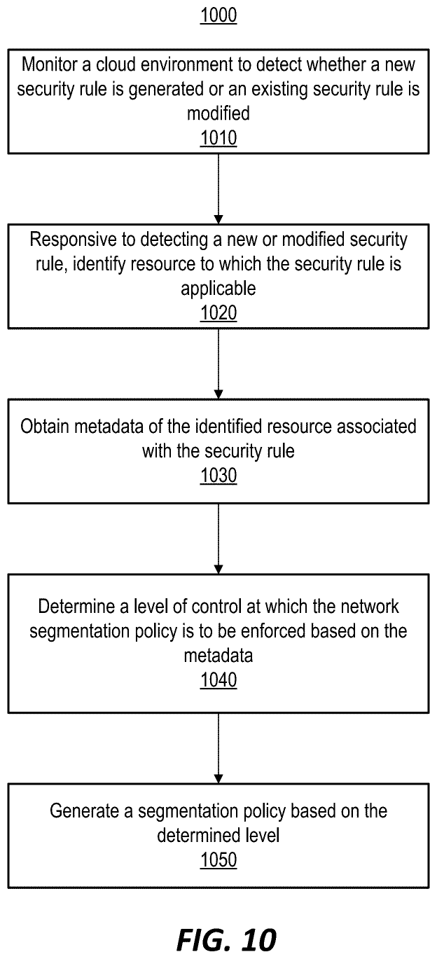

FIG. 10 is a flowchart of an example method 1000 for generating a network segmentation policy. Alternative embodiments may include more, fewer, or different steps from those illustrated in FIG. 10, and the steps may be performed in a different order from those illustrated in FIG. 10. The method 1000 may be implemented at the network security module 314.

In the embodiment shown in FIG. 10, the method 1000 begins with the network security module 314 monitoring 1010 the cloud computing environment to detect whether a new security rule is generated. Responsive to detecting a new security rule, the network security module 314 identifies 1020 resources for which the security rule is applicable. The network security module 314 accesses 1030 metadata associated with the identified resource. In some embodiments, the network security module 314 accesses a metadata database to extract metadata associated with the identified resource. The network security module 314 determines 1040 a control level at which the security rule is to be enforced based on the metadata associated with the identified resource and generates 1050 a network segmentation policy based on the determined level.

The embodiments described above automate and simplify the management of network security within cloud computing environments, particularly for enterprises with extensive and complex cloud infrastructure. Such automation reduces the need for manual intervention, lowering the risk of errors and significantly easing the burden of security management. Moreover, the embodiments described above support multi-layer security controls, enabling a more nuanced and effective approach to securing cloud environments. By automatically identifying the appropriate control level for each security rule based on the relationships between resources, the system can tailor segmentation policies more precisely, enhancing overall security and ensuring that segmentation policies are enforced at all times while being responsive of the dynamic cloud environment.

### Automated Policy Management Using Cloud Contexts and Flows

Even after overcoming the initial hurdle of establishing a coherent policy, ensuring its validity subsequently is still a daunting task. Given the dynamic and ever-changing nature of the cloud landscape, it is increasingly difficult to confirm that the policy remains effective, specifically in allowing only the necessary traffic. This challenge is compounded by enterprises' preference to avoid installing agents on resources and inability to install agents on Platform as a Service (PaaS) offerings, opting instead to utilize existing cloud-native controls such as Security Groups, Network Access Control Lists (NACLs), Firewalls, etc.

Further, manually generating a network segmentation policy, such as allowing traffic from a web server to a database, is feasible as a one-time task. However, challenges arise in dynamic cloud computing environments. For instance, a virtual machine hosting the web server may scale up, or its IP address may change. Deciding where to implement this network segmentation policy and which control mechanism to use becomes complex and if not done properly can lead to quickly reach limits of the cloud native security controls.

The dynamic changes in cloud security controls often lead security operations teams to opt for quick solutions, such as exclusively using a single-level control, e.g., Security Groups (SGs) to program all security measures. However, this approach may result in chaos. SGs quickly reach their policy limits, leading to the duplication of policies across SGs since they are localized to specific resources. This problem creates a significant management challenge, as there is no straightforward method to determine whether a policy is actively used or can be safely deleted. Further, the rapid evolution of cloud security controls presents a significant challenge for core and edge computing environments.

Embodiments described herein address these challenges by continuously monitoring the context around resources, ensuring that an existing policy remains effectively enforced regardless of changes in the resources' scale, IP addresses or addition of newer resources.

In some embodiments, the cloud security module 314 is configured to monitor the cloud computing environment to detect whether a new cloud resource is created or whether an existing cloud resource is modified. Responsive to detecting that a new cloud resource is being created, or an existing cloud resource is modified, the cloud security module 314 obtains metadata of the new cloud resource (or the modified cloud resource) and compares metadata of the new or modified cloud resource with metadata of existing cloud resources in the cloud computing environment to identify an existing cloud resource that is same as the new cloud resource. The cloud security module 314 then updates a network segmentation policy that governs the existing cloud resource, causing the policy also to govern the new or modified cloud resource. Alternatively, or in addition, the cloud security module 314 may generate a new segmentation policy based on the network segmentation policy that governs a similar existing cloud resource, where the new segmentation policy is configured to govern the new or modified cloud resource.

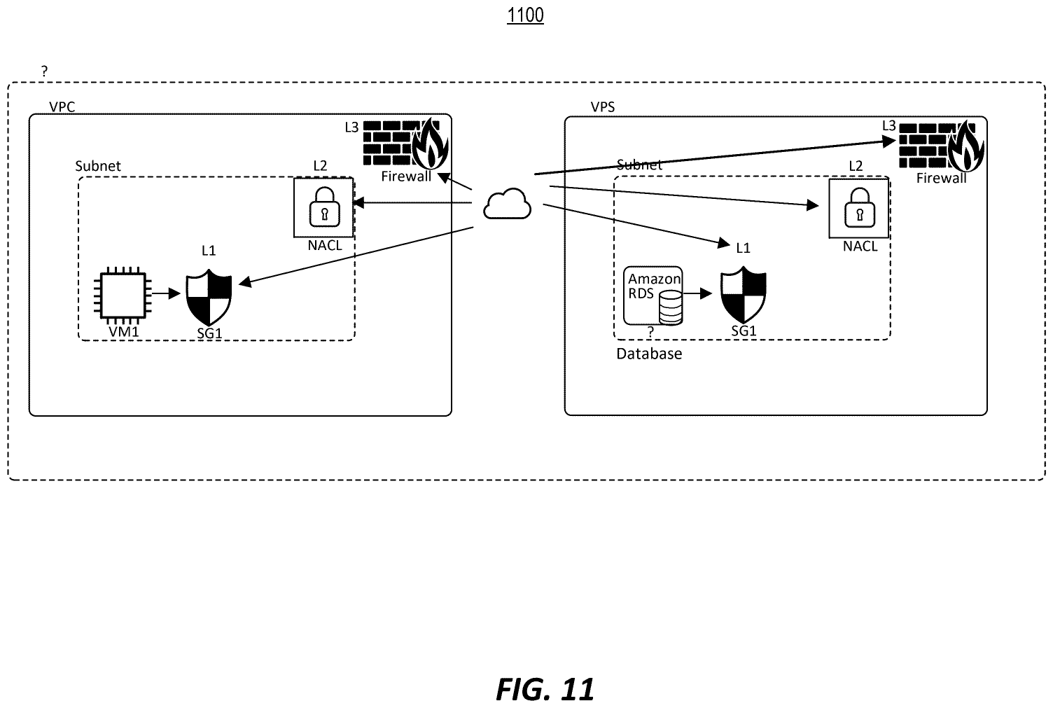

FIG. 11 illustrates an example cloud computing environment 1100 under a single cloud account (such as an AWS account) that includes two VPCs. To enable traffic flow between a virtual machine (VM1) acting as a web server and a relational database service (RDS) database within AWS, a network segmentation policy can be created. This network segmentation policy may be configured to permit communication from a web server to a database within a staging environment for a human resources management (HRM) application. The network segmentation policy may be as follows:

### Location: AWS

### Environment (Env): Stage

### Application (App): HRM

### Traffic Flow: Allow Web→DB

In the configuration, VM1 may be designated with the role “web,” and DB1 may be assigned the role “DB” within the policy engine. In some embodiments, the cloud security module 314 tags cloud resources with associated metadata. For example, VM1 may be tagged with “web,” and DB1 may be tagged with “DB.” In addition, both VM1 and DB1 may also be tagged with three additional labels based on other associated metadata. These tags may further allow identification and control of these resources.

Notably, this network segmentation policy aims to ensure secure communication between the virtual machine VM1 tagged with “web” and the database DB1 tagged with “DB.” The cloud security module 314 is configured to ensure that the network segmentation policy adheres to the tagged roles and labels to support the HRM application's operational requirements in the cloud computing environment when a new resource is generated or existing resources are scaled up. The cloud security module 314 intelligently selects the most suitable control to avoid exceeding the limits of cloud security mechanisms. Furthermore, in some embodiments, the cloud security module 314 automatically modifies a policy by applying a same segmentation policy at a higher and/or more common level of control, such as Network Access Control Lists (NACLs) in AWS subnets or Network Security Groups (NSGs) in Azure subnets or Security Lists in OCI Subnets, thereby preventing policy duplication across multiple controls.

In some embodiments, the cloud security module 314 analyzes tags associated with the resources of a network segmentation policy to enable communication from the web server (VM1) to the database (DB1) and implements the network segmentation policy based on the cloud context. In some embodiments, the cloud security module 314 determines whether the network segmentation policy should apply solely to Security Groups (SG), Network ACLs (NACL), or a combination of both or require programming at the Firewall level, especially if it involves cross-account activities. Additionally, it may also decide whether to program just Ingress policies or both Egress (outgoing) and Ingress (incoming) network traffic.

In some embodiments, the cloud security module 314 is also configured to identify additional applicable resources based in part on matching tags, labels, and metadata. For example, the cloud security module 314 may determine that the above segmentation policy is to be applied to other resources tagged with “web” and “DB” in a pre-stage environment, such that a new segmentation policy below is automatically generated or applied without any manual input from users.

### Location: AWS

### Environment (Env): Pre-stage

### Application (App): HRM

### Traffic Flow: Allow Web→DB

Alternatively, or in addition, the cloud security module 314 may modify the existing segmentation policy to cause the existing segmentation policy to cover the pre-stage environment further. In some embodiments, a new segmentation policy may be generated, or an existing segmentation policy may be modified preemptively. This preemptive approach ensures that the network segmentation policy is in place even before traffic flows begin, enhancing the cloud security module 314's capability to adapt to and manage security segmentation policies across different stages of the deployment lifecycles. A user can determine whether to activate the automatic control feature in some embodiments.

In some embodiments, some cloud segmentation policies are designed to be applied across a multitude of security controls, encompassing diverse cloud and hybrid models. In some embodiments, both allowed and denied traffic, as dictated by these cloud segmentation policies, is reported back to the cloud security module 314. In some embodiments, the cloud security module 314 also captures and reports on traffic flows that its existing cloud segmentation policies might not directly influence, providing a comprehensive view of network activity. In some embodiments, the cloud security module 314 also captures and reports all traffic flows, providing a comprehensive view of network activity across all clouds and environments.

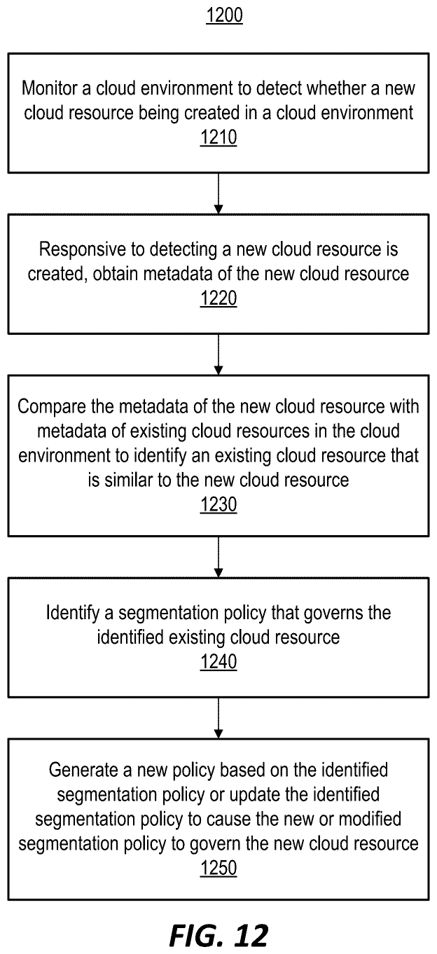

FIG. 12 is a flowchart of a method 1200 for automatically generating a new segmentation policy or modifying an existing segmentation policy. Alternative embodiments may include more, fewer, or different steps from those illustrated in FIG. 12, and the steps may be performed in a different order from those illustrated in FIG. 12. The method may be implemented at the cloud security module 314.

In the embodiment shown in FIG. 12, the method 1200 begins with the cloud security module 314 monitoring 1210 a cloud computing environment to detect whether a new resource is being created in a cloud computing environment or any existing cloud resource gets updated such as changing of the IP address. Responsive to detecting a new cloud resource is created, the cloud security module 314 obtains 1220 metadata of the new cloud resource or gets updated metadata of the existing resource and compares 1230 the metadata of the new cloud resource with metadata of existing cloud resources in the cloud computing environment to identify an existing cloud resource that is similar to the new cloud resource or identify which resource has been updated. This may include applying a similarity module to the metadata of the new cloud resource and metadata of the existing cloud resources to determine similarity scores and selecting an existing cloud resource with a similarity score greater than a threshold as one that is similar to the new cloud resource.

Metadata of a resource may be recorded in a predefined data structure, such as a JSON object. Below is an example of metadata that may be collected for a VM in Azure and recorded in a JSON object:

```
{
  “resource_map”: {
    “56f74f4d-ef70-5dd8-8938-ced7c0dc47ee”: {
      “id”: “56f74f4d-ef70-5dd8-8938-ced7c0dc47ee”,
      “csp_id”: “/subscriptions/ae23fa2a-3297-465a-bd0f-
07d4c518367c/resourceGroups/containers-
qa/providers/Microsoft.Compute/virtualMachines/gfandl-aks-george-vm5”,
      “account_id”: “ae23fa2a-3297-465a-bd0f-07d4c518367c”,
      “tenant_id”: “e7f1b037-16e2-5ada-8db4-eb51351a5f63”,
      “cloud”: “azure”,
      “name”: “gfandl-aks-george-vm5”,
      “object_type”: “Microsoft.Compute/virtualMachines”,
      “region”: “eastus”,
      “state”: “Succeeded”,
      “tags”: {
        “ConfigHash”:
        “de44719023dbdf2722f7773b4981e4046e2f7e7a”,
        “Name”: “vm5”,
        “Owner”: “george.fandli”,
        “Project”: “qa_pipeline:gfandli-aks-george”,
        “Source”: “containers_qa_pipeline”,
        “StartDate”: “2023-09-18”,
        “Team”: “containers”
      },
      “created_at”: “2023-10-03T01:25:59.074359Z”,
      “azure”: {
        “virtual_machine”: {
          “vnet_id”: “469e6c5e-666c-5d39-86ec-406b2f01747f”,
          “subnet_id”: “662d2113-eea2-5714-9ed2-ffe51f5a2d74”,
          “subnet_ids”: [
            “662d2113-eea2-5714-9ed2-ffe51f5a2d74”
          ],
          “nsg_ids”: [
            “50940eca-f8a4-59ab-957a-0e79b10cafd8”
          ],
          “nic_ids”: [
            “28f4fbe6-9347-54f3-83b9-00e93aa99611”
          ],
          “ip_config_ids”: [
            “4eca8721-c8ee-52d7-a073-8093c586d886”
          ]
        }
      },
      “detail_type”: “virtual_machine”,
      “virtual_machine”: {
        “vnet_id”: “469e6c5e-666c-5d39-86ec-406b2f01747f”,
        “subnet_id”: “662d2113-eea2-5714-9ed2-ffe51f5a2d74”,
        “subnet_ids”: [
          “662d2113-eea2-5714-9ed2-ffe51f5a2d74”
        ],
        “nsg_ids”: [
          “50940eca-f8a4-59ab-957a-0e79b10cafd8”
        ],
        “nic_ids”: [
          “28f4fbe6-9347-54f3-83b9-00e93aa99611”
        ],
        “ip_config_ids”: [
          “4eca8721-c8ee-52d7-a073-8093c586d886”
        ]
      }
    },
    “ac59c2e7-aa74-5707-9a4c-801524c19231”: {
      “id”: “ac59c2e7-aa74-5707-9a4c-801524c19231”,
      “csp_id”: “i-02e776df5650242d2”,
      “account_id”: “158256226745”,
      “tenant_id”: “e7f1b037-16e2-5ada-8db4-eb51351a5f63”,
      “cloud”: “aws”,
      “object_type”: “AWS::EC2::Instance”,
      “category”: “EC2”,
      “region”: “us-east-2”,
      “state”: “running”,
      “tags”: {
        “aws:autoscaling:groupName”: “eks-68bd7c4e-ffbb-d8ca-fb9c-
434a461b086f”,
        “aws:ec2:fleet-id”: “fleet-173de184-d106-443c-2eb2-
0500f5a67445”,
        “aws:ec2launchtemplate:id”: “lt-0fa21f97b8c5ce9cd”,
        “aws:ec2launchtemplate:version”: “7”,
        “aws:eks:cluster-name”: “staging-2”,
        “eks:cluster-name”: “staging-2”,
        “eks:nodegroup-name”: “lumos-eks-node-group-staging-2-core”,
        “k8s.io/cluster-autoscaler/enabled”: “true”,
        “k8s.io/cluster-autoscaler/staging-2”: “owned”,
        “kubernetes.io/cluster/staging-2”: “owned”
      },
      “created_at”: “2023-10-03T01:25:57.472362Z”,
      “aws”: {
        “ec2_instance”: {
          “subnet_id”: “f8fe953b-7aca-51af-b968-cabc180054fc”,
          “subnet_ids”: [
            “f8fe953b-7aca-51af-b968-cabc180054fc”
          ],
          “security_group_ids”: [
            “89e4489c-b6b2-56b2-8a39-ba33d5f43925”
          ],
          “eni_ids”: [
            “ec2d4051-344b-583b-97ec-1c7f95728e87”,
            “7dfa555d-3894-5c92-8de6-44c0f9805106”
          ]
        }
      },
      “detail_type”: “ec2_instance”,
      “ec2_instance”: {
        “subnet_id”: “f8fe953b-7aca-51af-b968-cabc180054fc”,
        “subnet_ids”: [
          “f8fe953b-7aca-51af-b968-cabc180054fc”
        ],
        “security_group_ids”: [
          “89e4489c-b6b2-56b2-8a39-ba33d5f43925”
        ],
        “eni_ids”: [
          “ec2d4051-344b-583b-97ec-1c7f95728e87”,
          “7dfa555d-3894-5c92-8de6-44c0f9805106”
        ]
      }
    }
  }
}
```

Similar to the above example, a metadata set may be collected for each resource. The metadata of the new cloud resource may be compared with the metadata of existing cloud resources in the cloud computing environment. In another embodiment, more or less metadata may be collected for each resource along with relationships that may be different that depicted in the example above.

The cloud security module 314 identifies 1240 a network segmentation policy that governs the identified existing cloud resource. The cloud security module 314 generates 1250, a new segmentation policy based on the identified segmentation policy, or updates the identified segmentation policy to cause the new or modified segmentation policy to govern the new cloud resource. The new or modified segmentation policy allows or denies traffic between two resources in a single direction or both directions.

Generating a new segmentation policy includes determining a control level at which a network segmentation policy is to be enforced and generating the new segmentation policy based on the determined control level. In some embodiments, the cloud security module 314 determines the control level by traversing resources associated with the network segmentation policy in each control level and determining the most effective control to enforce.

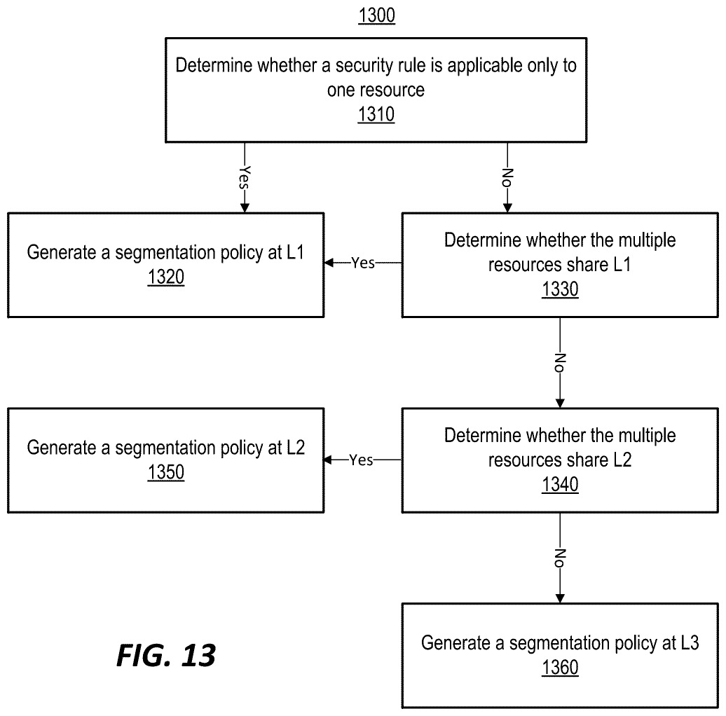

FIG. 13 is a flowchart of an example method 1300 for determining a control level at which a security rule is to be enforced in accordance with one or more embodiments. Alternative embodiments may include more, fewer, or different steps from those illustrated in FIG. 13, and the steps may be performed in a different order from those illustrated in FIG. 13. Method 1300 may be implemented at the cloud security module 314.

In the embodiment shown in FIG. 13, the method 1300 begins with the cloud security module 314 determining 1310 whether the security rule is applicable only to one resource. Responsive to determining that the network segmentation policy is only applicable to one resource (yes), the cloud security module 314 generates 1320 a network segmentation policy at a first layer. Otherwise, responsive to determining that the network segmentation policy is not only applicable to one resource (no), the cloud security module 314 determines 1330 whether the multiple resources share the first layer. Responsive to determining that the multiple resources share the first layer (yes), the cloud security module 314 also generates 1320 a network segmentation policy rules at a first layer. Responsive to determining that the multiple resources do not share the first layer (no), the cloud security module 314 determines 1340 whether the multiple resources share a same second level. Responsive to determining that the resources share a same second level (yes), the cloud security module 314 generates 1350 a network segmentation policy at the second layer. Responsive to determining that the resources do not share the same second level (no), the cloud security module 314 generates (1360) a network segmentation policy at a third level.

Even though the example method 1300 relates to a 3-level control system, the principles described herein may be implemented in lower or higher-level control systems, such as 2-level control systems, 4-level control systems, or even higher-level control systems.

In some embodiments, traffic patterns exhibit similarities across a multi-cloud setup or within different environments of a same cloud infrastructure. In some embodiments, the cloud security module 314 is also configured to identify and analyze these patterns and generate new policies or provide policy adjustments based on the patterns. By leveraging these advanced capabilities of cloud security module 314, enterprises can achieve a unified security management framework that not only applies appropriate cloud segmentation policies across various platforms but also adapts to changing traffic patterns and environments. This adaptability enables maintaining robust security measures in the face of the evolving cloud landscape and threat vectors.

The above-described embodiments address the complex challenges of managing security policies in rapidly changing cloud environments, offering a solution that enhances security through zero trust segmentation, simplifies policy management, and ensures the effectiveness of cloud security controls over time.

### Automated Enforcement of Segmentation Policies in a New Account on its Creation in an Onboarded Cloud Platform

Enterprises are experiencing a significant increase in cloud accounts created by IT teams for developers, such as AWS accounts, OCI compartments and Azure subscriptions. Even though they are called by different terms in different clouds—the common term to use is account. This trend is encouraged by cloud providers, advocating the use of accounts, compartments, and subscriptions as the primary unit of operation instead of individual VPCs or VNETs. While this approach offers improved segregation, allowing multiple developers to operate independently within distinct account boundaries, it also leads to increased usage and, consequently, account sprawl. This trend presents a substantial challenge for security teams, who must monitor each account separately.

Most security solutions are designed to operate within the scope of a single account, requiring policies to be tailored for resources specific to that account. Furthermore, the creation of new accounts may occur without centralized governance, leaving IT teams unaware of their existence. Some existing mechanisms allow for the establishment of static, enterprise-wide policies, but these measures are often inadequate for effectively segmenting the diverse range of applications deployed in the public cloud. Cloud providers may offer service control policies to restrict developer actions within an account, yet these do not prevent developers from potentially risky actions like opening a Security Group (SG) to the internet or initiating an EC2 instance for bitcoin mining. Even if IT or security teams implement native cloud security controls, developers can circumvent these by integrating their own controls within app configurations. This scenario doesn't necessarily indicate malicious intent; developers may simply be unaware of the implications of their actions, exacerbated by a lack of cohesive cloud-native controls and a confusing shared responsibility model.

Enterprises may install agents on resources associated with accounts. However, it is not feasible unless IT teams are aware of the new accounts or subscriptions. Even with awareness, access to these accounts for agent installation might not be possible, and certain Platform as a service (PaaS) resources, such as serverless Lambda functions, do not support agent installation.

The cloud security module 314 described herein solves the above-described problem by automatically detecting the creation of new accounts or subscriptions across cloud providers. The cloud security module 314 may apply predefined segmentation policies at an enterprise level, extending coverage to every new account or subscription without the need for manual intervention or agent installation. It could leverage APIs provided by cloud providers to enforce security controls and monitor configurations across all cloud computing environments, ensuring consistent security posture and compliance.

By integrating the enterprises' accounts with cloud providers with the system, enterprises gain the capability to incorporate any new accounts added to the enterprise automatically. This same principle may also be applied when onboarding a cloud tenant, such as an Azure Tenant, where the creation of new Azure subscriptions or accounts by the IT or provisioning team requires no additional actions from users to ensure their inclusion in the centralized security management platform.

With the appropriate permissions, the system continuously monitors onboarded cloud tenants (e.g., AWS organizations, Azure tenants, and OCI tenants) for the addition of new accounts, subscriptions, and resources. This proactive approach ensures that all new enterprises are promptly identified and integrated into the corresponding enterprise's environment.

In some embodiments, enterprises have the ability to craft segmentation policies for their cloud computing environments based on specific metadata. Upon the creation of a new resource or account, the system automatically synchronizes the data. If the metadata of these resources aligns with the criteria defined in existing policies, the system applies these segmentation policies, securing the accounts from the outset.

In some embodiments, enterprises are empowered to establish segmentation policies for applications across similar environments beyond those that rely on exact metadata matches. As discussed above, the cloud security module 314 is able to tag resources with their associated metadata and use the tags to generate new segmentation policies or modify existing segmentation policies.

For example, a security rule targeted at Account ID 1234, VPC ID vpc-xyz, and subnet ID subnet-abc will only affect resources meeting these exact criteria. Conversely, a security rule delineated for Cloud=AWS, Env=Dev, and App=CRM—where ‘Cloud’ serves as metadata and ‘Env’ and ‘App’ may derive from tags or metadata—can be universally applied to all accounts fitting these broad criteria, including those established after the policy's creation.

Additionally, in instances where a mapping dimension is absent, the system can infer the applicability of a policy to certain resources based on similarities in metadata of resources, traffic flows and other dimensions to those observed in existing accounts or across the cloud computing environment.

This strategic approach ensures that segmentation policies are applied consistently across an enterprise's cloud infrastructure and adapt dynamically to accommodate new accounts and changing cloud landscapes, thereby maintaining a robust security posture without manual intervention.

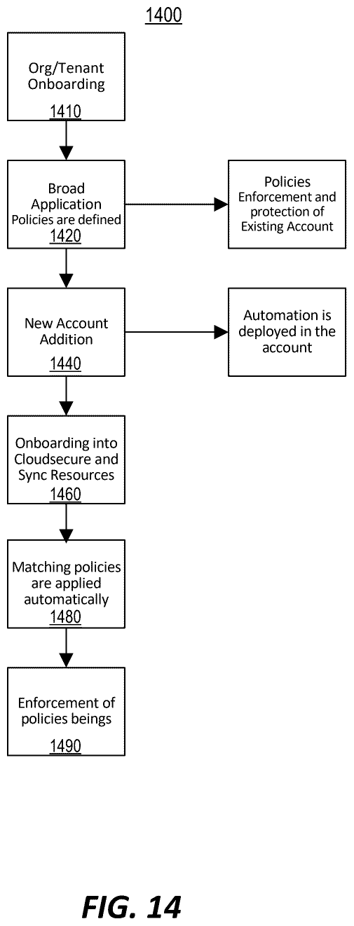

FIG. 14 is a flowchart of workflow 1400 for onboarding a new tenant or a new enterprise in a cloud computing environment in accordance with one or more embodiments. Alternative embodiments may include more, fewer, or different steps from those illustrated in FIG. 14, and the steps may be performed in a different order from those illustrated in FIG. 14. In some embodiments, the cloud security module 314 includes a built-in wizard that guides users through onboarding. For each cloud account type, the cloud security module 314 may supply users with a pre-populated CloudFormation template, Terraform code or PowerShell script, setting up all requisite identity and access management (IAM) users or roles and permissions or establishing application registration and permissions. Once onboarding is completed, the cloud security module 314 is able to automatically “learn” about the cloud computing environments based on metadata associated with resources, identifying workloads, and compiling traffic flow data.

In the embodiment shown in FIG. 14, when a new tenant is onboarding 1410, a set of broad application policies (e.g., segmentation policies) is defined 1420. These policies may be configured and enforced to protect existing accounts. At a later time, a new account may be added 1440, and automation 1450 may be deployed in the new account. The new account is onboarded 1460 into the cloud security module 314, and metadata of the resources associated with the new account are synchronized with the cloud security module 314. The cloud security module 314 then identifies 1480 matching segmentation policies in existing cloud accounts and enforces 1490 the identified matching segmentation policies in the new account. In some embodiments, the identification of matching segmentation policies may include comparing the metadata of the resources in the new account and metadata of resources in existing accounts to identify similar resources and identifying segmentation policies associated with the identified similar resources.

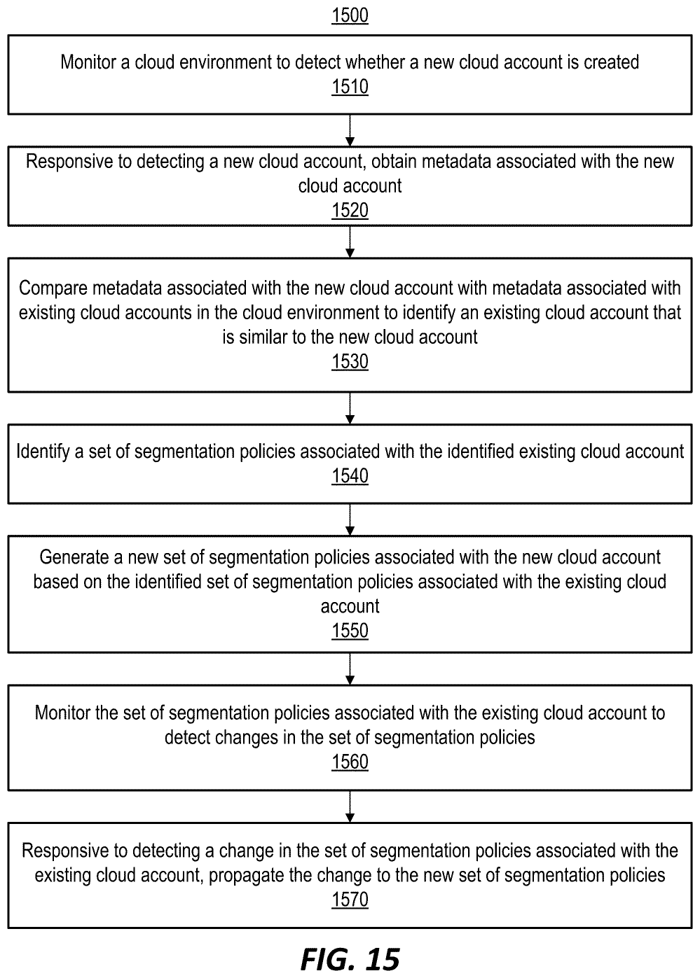

FIG. 15 is a flowchart of a method 1500 for generating and enforcing segmentation policies in new cloud accounts. Alternative embodiments may include more, fewer, or different steps from those illustrated in FIG. 15, and the steps may be performed in a different order from those illustrated in FIG. 15. The method 1500 may be performed by the cloud security module 314.

In the embodiment shown in FIG. 15, the method 1500 begins with the cloud security module 314 monitoring 1510 a cloud computing environment, to detect whether a new cloud account has been created. Responsive to detecting a new cloud account, the cloud security module 314 obtains 1520 metadata associated with the new cloud account. In some embodiments, the cloud security module 314 identifies resources associated with the new cloud account and obtains metadata of the resources associated with the new cloud account.

The cloud security module 314 compares 1530 metadata associated with the new cloud account with metadata associated with existing cloud accounts in the cloud computing environment to identify an existing cloud account that is similar to the new cloud account. In some embodiments, the cloud security module 314 compares metadata of the resources associated with the new cloud account with metadata of resources associated with the existing cloud accounts to identify resources in an existing cloud account that are similar to the resources associated with the new cloud account.

The cloud security module 314 identifies 1540 a set of segmentation policies associated with the identified existing cloud account. In some embodiments, the cloud security module 314 identifies a set of segmentation policies that are applied to the resources in the existing cloud account that are similar to the resources associated with the new cloud account. In some embodiments, for each resource in the new cloud account, a set of segmentation policies are identified.

The cloud security module 314 generates 1550 a new set of segmentation policies associated with the new account based on the identified set of segmentation policies associated with the similar existing cloud account. In some embodiments, for each resource in the new cloud account, a new set of segmentation policies is generated. The new set of segmentation policies is enforced against the corresponding resource in the new cloud account.

In some embodiments, the cloud security module 314 monitors 1560 the set of segmentation policies associated with the existing cloud account, to detect changes in the set of segmentation policies. Responsive to detecting a change in the set of segmentation policies associated with the existing cloud account, the cloud security module 314 propagates 1570 the change to the new set of segmentation policies associated with the new cloud account. In some embodiments, for each resource in the new cloud account, there is a similar cloud resource in the existing cloud account. When the similar cloud resource in the existing cloud account changes, the cloud security module 314 automatically propagates the same change to the set of segmentation policies to the resource in the new account. In some embodiments, multiple new accounts are generated, and each of the new accounts might include resources similar to resources in an existing cloud account. Responsive to a change in a set of segmentation policies associated with the resource in the existing cloud account, the change is propagated to the corresponding sets of segmentation policies associated with the resource in each of the new accounts.

The above-described embodiments provide a comprehensive solution for managing cloud security at scale, addressing the challenges of account sprawl, manual policy enforcement, and the dynamic nature of cloud environments. It offers enterprises automated, scalable, and adaptable security management capabilities that ensure a consistent and robust security posture across all cloud accounts and resources.

### Application Discovery: Automatic Assignment and Enforcement of Appropriate Segmentation Policies to an Application Instance

Currently, there is no easy way to group all cloud resources used by a cloud application so that enterprises can assign and enforce segmentation policies to allow/prevent interactions among different cloud applications. A cloud application typically includes multiple, potentially thousands, compute/storage cloud resources deployed across single/multiple cloud providers, which interact with each other to provide functionality. Enterprises typically run multiple copies of cloud applications in different environments to serve different user groups. During the lifetime of an application, resources can be added, deleted, and stopped. It is a tedious manual process to figure out what cloud resources are used by an application and then write separate segmentation policies across multiple cloud providers to enforce using cloud native controls for cloud applications.

The embodiments described herein include using cloud metadata to automatically determine a definition of which components in the cloud constitute an application and the environment in which they are deployed. This allows automatic assignment and enforcement of the appropriate segmentation policies to the application instance.

A cloud computing environment may onboard one or more cloud accounts. Once onboarded and access information is provided, the cloud security module 314 identifies cloud resources deployed in the accounts. In some embodiments, the cloud security module 314 automatically starts an application discovery procedure that uses a combination of cloud tags, cloud metadata, and account information to automatically group resources deployed across different environments/cloud service providers together and assign application labels and environment labels to those resources. In some embodiments, each resource in an application gets an application/environment label. If a resource is added/deleted, the discovery process automatically rediscovers applications and updates resources based on cloud metadata. Custom segmentation policies can be applied to application/environment labels, which eventually get enforced on cloud resources using cloud native security controls which can be programmed by utilizing cloud provider application programming interfaces (APIs).

The cloud security module 314 gathers information about application deployments. The deployment information may include a combination of cloud accounts, regions, virtual networks, subnets, availability zones, and tags. In some embodiments, for each application deployment, a set of deployment data and/or a set of definition data may be collected or generated. In some embodiments, the set of deployment data includes an environment label, which serves as a unique identifier for a particular deployment (which may be in the form of a key-value pair), alongside cloud metadata that includes various elements such as cloud tags, virtual networks, subnets, cloud accounts, and cloud regions. On the other hand, the set of definition data may include an application label (which may be in the form of another unique key-value pair), along with a set of tags or a combination of a deployment and selected cloud resources like EC2 instances, VMs, etc.

An extension to deployments and definitions is label mappings, which map labels to resources. These mappings may be used to increase the context and granularity of applications. These mappings may be added optionally, but when used the mappings are associated with applications automatically or manually.

Once information about application deployments is gathered and definitions of these application deployments are generated, the cloud security module 314 can begin a discovery phase. There are two mechanisms for discovery. The first is automatic. The automatic mechanism queries resources across all clouds with combinations of cloud metadata (accounts, regions, VPCs, subnets, and so on) and cloud tags. In some embodiments, the cloud security module 314 looks at cloud tags such as “app,” “App,” “AppName,” “appname,” “appid,” “app_name,” “app-name,” “app-id,” “app_id,” “name,” “Name,” “application,” “Application.” The cloud security module 314 also allows enterprises to input custom tags or a combination of tags used in their environment).

In some embodiments, during the discovery phase, the cloud security module 314 queries resources across all clouds using tags. The cloud security module 314 may determine whether a resource has already been assigned to a definition. Any resources that have already been assigned to a definition may be excluded. The cloud security module 314 may also determine whether a resource is part of an unapproved draft definition or an approved definition. The cloud security module 314 may also identify deleted resources and ensure that any deleted resources are invalidated.

Following this, the cloud security module 314 pulls all deployments and iterates over unassigned resources. In some embodiments, this iteration includes checking the tags of a resource based on cloud, and identifying intersecting properties between a resource and deployments. In some embodiments, the cloud security module 314 may traverse the cloud computing environment to identify virtual networks. If a virtual network is found, the cloud security module 314 then traverses the virtual network to identify subnets. If a subnet is found, the cloud security module 314 then traverses the subnet to identify resources. Special considerations are made for resources such as VPCs, ENIs, and SGs to ensure they are correctly compared and verified within their respective networks. If a resource is a virtual private network (VPC), the cloud security module 314 just traverses the VPC. If a resource is ENI, the ENI is compared with VPC and subnet IDs. SG may have EC2 and/or ENI. Thus, the cloud security module 314 also determines whether an SG is in a VPC. Once the iteration is completed, the identified resources are stored with application and deployment datasets. The discovery phase is marked as complete if resources are found; otherwise, the discovery state is marked with no results found.

Once the discovery phase is completed, the cloud security module 314 allows for segmentation governance. An enterprise can choose to approve any network traffic between resources of the discovered or manually created application, which will then allow for policies to be configured, traffic flows to be reviewed, and resources to be grouped by application in various data visualizations that enable enterprises to achieve segmentation. The cloud security module 314 supports automatic or manual user intervention for approval of identified application definitions and, thereby, segmentation governance.

When approving an application, the cloud security module 314 may collect all application deployments to be approved and create a corresponding instance for each one. This may be used for scoping application rulesets. In addition, the cloud security module 314 may maintain a mapping of the instances and their associated application labels. This mapping powers label-based policies.

In some embodiments, the cloud security module 314 is configured to visualize the discovered applications. Referring back to FIG. 4C, GUI 400C depicts a list of applications discovered via the discovery phase. Each application is associated with a deployment, a cloud account, and a resource (inventory column). Further, each application may or may not be labeled with a tag. A tag may be automatically generated based on metadata associated with the application or metadata associated with the resources of the application. A tag may also be generated manually by a user. Each application also includes a “map” link and a “policy” link. The “map” link takes a user to a respective mapping of instances and their associated application labels. The “policy” link takes a user to segmentation policies associated with the resources in the application.

For all applications, there may be an “All Environments” ruleset in addition to per-deployment policies, which serve to capture broad policies across an application and its deployments. The cloud security module 314 continuously monitors enterprise cloud resources, rediscovers application resources and triggers approval workflow, which can be auto-approval or require user intervention based on custom settings.

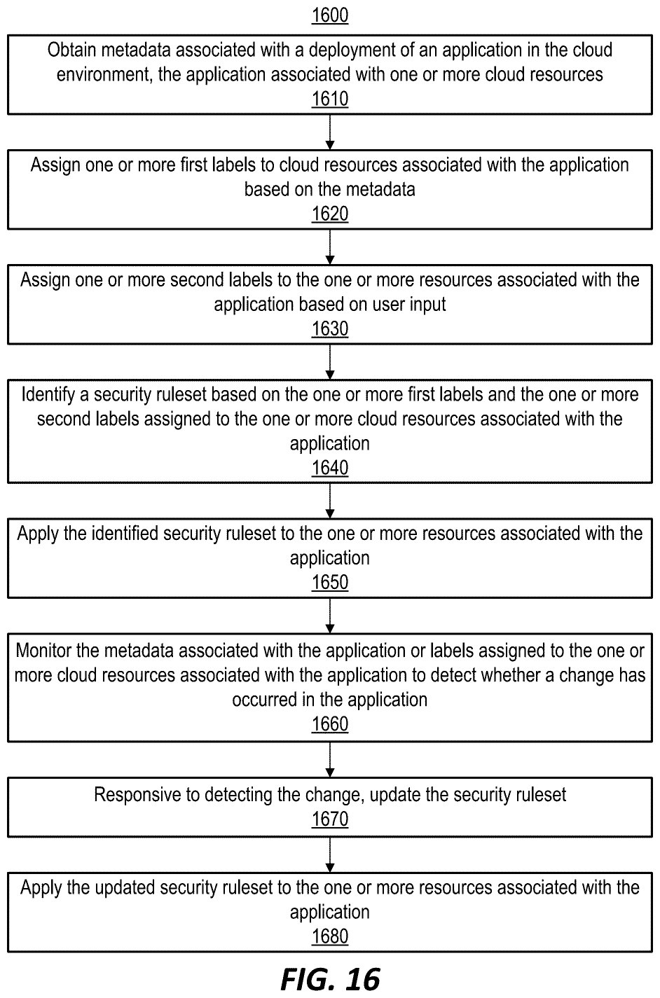

FIG. 16 is a flowchart of an example method 1600 for discovering and segmentation governance of applications in a cloud computing environment, in accordance with one or more embodiments. Alternative embodiments may include more, fewer, or different steps from those illustrated in FIG. 16, and the steps may be performed in a different order from those illustrated in FIG. 16. The method 1600 may be implemented in the cloud security module 314.

In the embodiment shown in FIG. 16, the method 1600 begins with the cloud security module 314 obtaining 1610 metadata associated with a deployment of an application in the cloud computing environment. The deployment of the application is associated with one or more cloud resources. Each of the one or more cloud resources is associated with metadata. In some embodiments, obtaining metadata associated with the application includes identifying one or more cloud resources associated with the deployment of the application and obtaining metadata associated with the one or more cloud resources.

In some embodiments, the cloud security module 314 assigns 1620 one or more labels to cloud resources associated with the application based on the metadata. Alternatively, or in addition, the cloud security module 314 assigns 1630 one or more labels to the one or more resources associated with the application based on user input. The cloud security module 314 identifies 1640 as a security ruleset based on the one or more labels assigned to the one or more cloud resources associated with the deployment of the application.

The cloud security module 314 applies 1650 of the identified security ruleset to one or more resources associated with the application. In some embodiments, for each security rule in the security ruleset, the cloud security module 314 determines a control level at which a network segmentation policy is to be applied (which may correspond to the method 1300 of FIG. 13), and generates a network segmentation policy for the determined control level.

The cloud security module 314 monitors 1660 the metadata of the deployment of the application or labels assigned to the one or more cloud resources associated with the deployment of the application to detect whether a change has occurred in the deployment of the application. Responsive to detecting the change, the cloud security module 314 updates 1670 the security ruleset, and applies 1680 the updated security ruleset, to the one or more resources associated with the application.

In some embodiments, the cloud security module 314 discovers deployments of a plurality of applications and assigns labels to resources associated with each deployment of the plurality of applications. In some embodiments, the cloud security module 314 traverses the cloud computing environment to identify one or more virtual networks. For each of the one or more virtual networks, the cloud security module 314 traverses the virtual network to identify one or more subnets. For each of the one or more subnets, the cloud security module 314 traverses the subnet to identify one or more cloud resources.

In some embodiments, each discovered deployment of an application, the cloud security module 314 identifies network traffic patterns between resources associated with the deployment of the application and visualizes the network traffic pattern in a GUI. Referring to FIG. 4D, GUI 400D depicts a network traffic pattern of a deployment of an application in accordance with one or more embodiments.

Among all the deployments, there may be a plurality of deployments of a same application in the cloud computing environment across different environments. In some embodiments, the cloud security module 314 detects the change to a first deployment of the application and automatically propagates the change to a second deployment of the application.

The embodiments described above address a challenge in managing cloud applications across multiple environments and cloud providers. The embodiments automatically discover cloud applications and associated resources and enable assignment and enforcement of segmentation policies to regulate interactions among different resources in cloud applications.

### Computing System Architecture

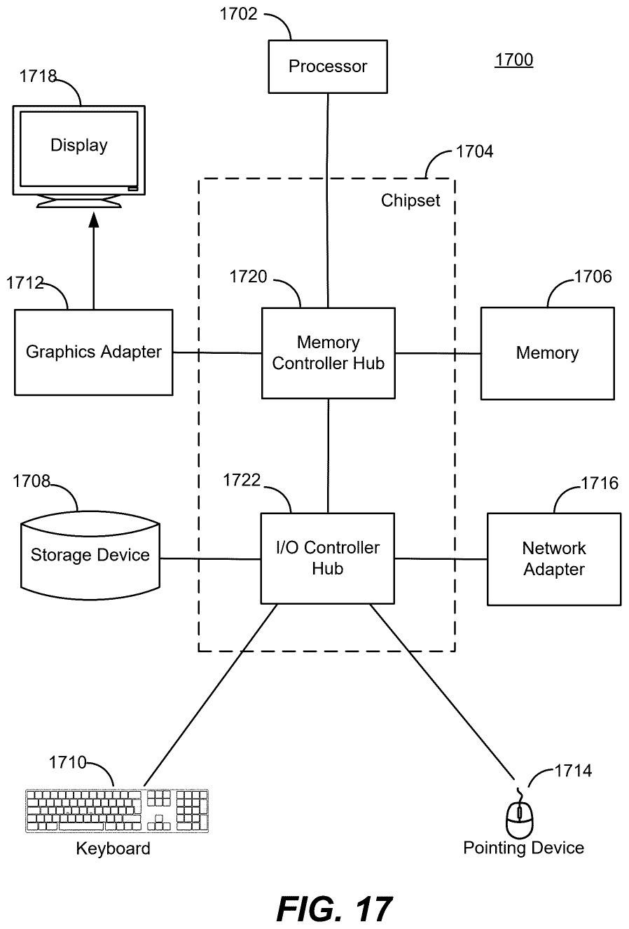

FIG. 17 is a block diagram of an example computer 1700 suitable for use in the networked computing environment 100 of FIG. 1. The computer 1700 is a computer system and is configured to perform specific functions as described herein. For example, the specific functions corresponding to cloud security module 314 may be configured through the computer 1700.

The example computer 1700 includes a processor system having one or more processors 1702 coupled to a chipset 1704. The chipset 1704 includes a memory controller hub 1720 and an input/output (I/O) controller hub 1722. A memory system having one or more memories 1706 and a graphics adapter 1712 are coupled to the memory controller hub 1720, and a display 1718 is coupled to the graphics adapter 1712. A storage device 1708, keyboard 1710, pointing device 1714, and network adapter 1716 are coupled to the I/O controller hub 1722. Other embodiments of the computer 1700 have different architectures.

In the embodiment shown in FIG. 17, the storage device 1708 is a non-transitory computer-readable storage medium such as a hard drive, compact disk read-only memory (CD-ROM), DVD, or a solid-state memory device. The memory 1706 holds instructions and data used by the processor 1702. The pointing device 1714 is a mouse, track ball, touchscreen, or other types of a pointing device and may be used in combination with the keyboard 1710 (which may be an on-screen keyboard) to input data into the computer 1700. The graphics adapter 1712 displays images and other information on the display 1718. The network adapter 1716 couples the computer 1700 to one or more computer networks, such as network 110.

The types of computers used by the enterprises of FIGS. 1 through 3 can vary depending upon the embodiment and the processing power required by the enterprise. For example, the segmentation server 120 might include multiple blade servers working together to provide the functionality described. Furthermore, the computers can lack some of the components described above, such as keyboards 1710, graphics adapters 1712, and displays 1718.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification do not necessarily all refer to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for visualizing a segmented network. Thus, while particular embodiments and applications have been illustrated and described, it is to be understood that the described subject matter is not limited to the precise construction and components disclosed. The scope of protection should be limited only by the following claims.

What is claimed is:

1. A method for managing deployments of applications in a cloud computing environment, the method comprising:
obtaining metadata associated with a deployment of an application in the cloud computing environment, the deployment of the application associated with one or more cloud resources in the cloud computing environment;
assigning one or more first labels to cloud resources associated with the application based on the metadata;
assigning one or more second labels to the one or more resources associated with the application based on user input, the one or more first labels or second labels including an environment label indicating an environment in which the application is running, and an application label specifying a name of the application;
generating a security ruleset based on the labels assigned to the one or more resources associated with deployment of the application;
applying the security ruleset to the one or more resources associated with the deployment of the application;
monitoring the metadata associated with the resources included in the deployment of the application to detect whether a change has occurred in the application; and
updating the security ruleset applied to the one or more resources associated with the application in response to the detection of the change.

2. The method of claim 1, further comprising:
discovering deployments of a plurality of applications; and
assigning labels to resources associated with each deployment of the plurality of applications.

3. The method of claim 2, wherein discovering deployments of the plurality of applications comprises:
traversing the cloud computing environment to identify one or more virtual networks;
for each of the one or more virtual networks, traversing the virtual network to identify one or more subnets;
for each of the one or more subnets, traversing the subnet to identify one or more associated cloud resources.

4. The method of claim 3, further comprising, for each deployment of a discovered application:
identifying network traffic patterns between resources associated with the application; and
visualizing the network traffic pattern in a graphical user interface.

5. The method of claim 4, further comprising,
responsive to receiving a user input at the graphical user interface indicating to deny identified network traffic, generating a security rule to deny the identified network traffic in the cloud computing environment.

6. The method of claim 5, further comprising,
determining a control level at which the security rule is to be enforced; and
generating a network segmentation policy at the determined control level causing the identified network traffic to be denied.

7. The method of claim 6, further comprising,
identifying a new deployment of an application;
identifying a first security ruleset configured to control network traffic among resource in an existing deployment of the application; and
generating a second security ruleset configured to control network traffic among resources in the new deployment of the application.

8. The method of claim 7, further comprising,
identifying a security rule in the first security ruleset configured to control network traffic between a first set of resources associated with a set of tags in an existing deployment of the application; and
generating a new security rule in the second security ruleset to control network traffic between a second set of resources associated with the set of tags in the new deployment of the application.

9. The method of claim 7, further comprising,
responsive to determining that a security rule in one of the first security ruleset or the second security ruleset is changed, making a same change in a corresponding security rule in another one of the first security ruleset or the second security ruleset.

10. A non-transitory computer-readable medium having instructions encoded thereon that, when executed by one or more processors, cause the one or more processors to:
obtain metadata associated with a deployment of an application in a cloud computing environment, the deployment of the application associated with one or more cloud resources in the cloud computing environment;
assign one or more first labels to cloud resources associated with the application based on the metadata;
assign one or more second labels to the one or more resources associated with the application based on user input, the one or more first labels or second labels including an environment label indicating an environment in which the application is running, and an application label specifying a name of the application;
generate a security ruleset based on the labels assigned to the one or more resources associated with deployment of the application;
apply the security ruleset to the one or more resources associated with the deployment of the application;
monitor the metadata associated with the deployment of the application to detect whether a change has occurred in the application; and
update the security ruleset applied to the one or more resources associated with the application in response to the detection of the change.

11. The non-transitory computer-readable medium of claim 10, the instruction causing one or more processors to:
discover deployments of a plurality of applications; and
assign labels to resources associated with each deployment of the plurality of applications.

12. The non-transitory computer-readable medium of claim 11, discovering deployments of the plurality of applications comprising:
traversing the cloud computing environment to identify one or more virtual networks;
for each of the one or more virtual networks, traversing the virtual network to identify one or more subnets;
for each of the one or more subnets, traversing the subnet to identify one or more cloud resources.

13. The non-transitory computer-readable medium of claim 12, the instructions further causing the one or more processors to:
for each deployment of a discovered application,
identify network traffic patterns between resources associated with the application; and
visualize the network traffic pattern in a graphical user interface.

14. The non-transitory computer-readable medium of claim 13, the instructions further causing the one or more processors to:
responsive to receiving a user input at the graphical user interface, indicating deny an identified network traffic, generate a security rule to deny the identified network traffic in the cloud computing environment.

15. The non-transitory computer-readable medium of claim 14, the instructions further causing the one or more processors to:
determine a control level at which the security rule is to be enforced; and
generate a network segmentation policy at the determined control level causing the identified network traffic to be denied.

16. The non-transitory computer-readable medium of claim 15, the instructions further causing the one or more processors to:
identify a new deployment of an application;
identify a first security ruleset configured to control network traffic among resource in an existing deployment of the application; and
generate a second security ruleset configured to control network traffic among resources in the new deployment of the application.

17. The non-transitory computer-readable medium of claim 16, the instructions further causing the one or more processors to:
identify a security rule in the first security ruleset configured to control network traffic between a first set of resources associated with a set of tags in an existing deployment of the application; and
generate a new security rule in the second security ruleset to control network traffic between a second set of resources associated with the set of tags in the new deployment of the application.

18. The non-transitory computer-readable medium of claim 16, the instructions further causing the one or more processors to:
responsive to determining that a security rule in one of the first security ruleset or the second security ruleset is changed, make a same change in a corresponding security rule in the first security ruleset or the second security ruleset.

19. A computing system, comprising:
one or more processors; and
a non-transitory computer-readable medium having instructions encoded thereon that, when executed by one or more processors, cause the one or more processors to:
obtain metadata associated with a deployment of an application in a cloud computing environment, the deployment of the application associated with one or more cloud resources in the cloud computing environment;
assign one or more first labels to cloud resources associated with the application based on the metadata;
assign one or more second labels to the one or more resources associated with the application based on user input, the one or more first labels or second labels including an environment label indicating an environment in which the application is running, and an application label specifying a name of the application;
generate a security ruleset based on the labels assigned to the one or more resources associated with deployment of the application;
apply the security ruleset to the one or more resources associated with the deployment of the application;
monitor the metadata associated with the deployment of the application to detect whether a change has occurred in the application; and
update the security ruleset applied to the one or more resources associated with the application in response to the detection of the change.

20. The computing system of claim 19, the instructions further causing the one or more processors to:
discover deployments of a plurality of applications; and
assign labels to resources associated with each deployment of the plurality of applications.
